(19) United States
(12) Patent Application Publication
(10) Pub. No.: US 2013/0192532 A1
(43) Pub. Date: Aug. 1, 2013

(54) DYNAMIC KENNEL SYSTEMS AND METHODS

(71) Applicant: CBW Distribution LLC, Broomfield, CA (US)

(72) Inventor: Heidi Ann Ganahl, Broomfiled, CO (US)

(73) Assignee: CBW DISTRIBUTION LLC, Broomfield, CO (US)

(21) Appl. No.: 13/735,248

(22) Filed: Jan. 7, 2013

Related U.S. Application Data
(60) Provisional application No. 61/583,439, filed on Jan. 5, 2012.
(60) Provisional application No. 61/702,557, filed on Sep. 18, 2012.

(51) Int. Cl. A01K 1/00

(52) U.S. Cl. CPC A01K 1/00
USPC 119/474; 119/480; 29/428

(57) ABSTRACT

A dynamic kennel system for use in combination with a pre-existing barrier. One dynamic kennel system comprises at least one side panel rotatably interconnected to the pre-existing barrier and a gate rotatably interconnected to the at least one side panel. The at least one side panel and the gate are positionable in a first collapsed configuration such that the at least one side panel and the gate are situated substantially parallel with each other. The at least one side panel and the gate are also positionable in a second expanded configuration such that the at least one side panel and the gate are situated transverse with each other.

### PRIORITY

This application claims priority to both U.S. Provisional Application No. 61/583,439, filed Jan. 5, 2012, entitled Dynamic Kennel Configuration, and No. 61/702,557, filed Sep. 18, 2012, and entitled Dynamic Kennel System and Methods Associated Therewith; both of which are incorporated herein by reference.

### FIELD OF THE INVENTION

The present invention is related to interchangeable, movable and collapsible boarding kennels and the methods of use of the boarding kennels.

### BACKGROUND OF THE INVENTION

Various types of boarding kennels and enclosures have been developed to provide animals with an area for rest or sleep. However, past and current boarding kennels and animal enclosures are designed to be static and permanent. Currently available boarding kennels do not provide a kennel owner the ability to change the configuration of a set of kennels in order to accommodate for an increased number of animals in a facility nor do the current boarding kennels provide the ability to temporarily remove kennels to provide additional space for animal recreation or other needs.

### SUMMARY OF THE INVENTION

There is a need for additional kennel systems and methods that address one or more of the problems or shortcomings noted above. The present invention provides one or more embodiments to overcome the shortcomings of the current kennels available today.

It is to be understood that the present invention includes a variety of different versions or embodiments, and this Summary is not meant to be limiting or all-inclusive. This Summary provides some general descriptions of some of the embodiments, but may also include some more specific descriptions of other embodiments.

In at least one embodiment, a walled enclosure is provided comprising one or more anchors, one or more metal posts and one or more panels. The walled enclosure is configured as an animal play area wherein one or more anchors placed in the floor or flat platform have been provided. The one or metal posts are then attached to the anchors in the floor or flat platform and panels are attached to the metal posts to create a walled enclosure. The wall enclosure is designed to allow for the unencumbered movement throughout the facility.

In at least one embodiment, a system of configuring kennels is provided wherein a walled enclosure is provided which is attached to one or more anchors in a floor or flat platform. The walled enclosure is designed to allow for the unencumbered movement or recreation of animals such as dogs. The enclosure is then reconfigured from an animal recreation area into a kennel holding facility comprising a plurality of metal posts with a plurality of metal feet, a plurality of panels, a plurality of gates and a plurality of stability bars. The metal posts provided are square tubes with an appendage attached to each face of the tube. Each appendage on each post has a plurality of openings formed through the appendage or wing. Each metal post also is provided with a separate foot that can be attached to each post to provide a stable platform for the post. Panels are provided with a plurality of openings formed on each vertical side of the panel. One side of the panel is attached to one appendage on a metal post on the walled enclosure by aligning the openings on the side of the panel with the corresponding openings of the post appendage. The other side of the panel is also attached to an appendage on a second metal post by aligning the openings of the opposite side of the panel with the corresponding openings on the post appendage. This system of panels and posts can be repeated with an additional panel and post in order to create a kennel enclosure attached to the walled enclosure. A gate panel is then attached to one of the appendages on one of the metal posts at the entrance of the enclosure. A gate is then attached to the gate panel. A stabilization bar is placed attached above the gate and attached to the two metal posts, there the gate is also attached by attaching a wing to a post at the front of the kennel enclosure and attaching one end of the stabilization bar to the wing and the other end of the stabilization bar to the metal post on the opposite side of the entrance of the kennel enclosure, thereby creating a kennel enclosure with at least four metal posts, four feet, two panels, one stabilization bar, one gate panel and one gate. The system of kennel configuration provides that the one kennel enclosure may be erected and used 12 to 16 hours per day and the enclosed facility without the kennel enclosures is used 10 to 14 hours per day.

In at least one embodiment, an anchor is provided which has been mounted into a floor or flat platform. A metal post is then attached to an anchor mounted in the floor or flat platform. A panel is provided where the panel is attached to an appendage on the metal post attached to the anchor. This step is repeated with a second metal post attached to an anchor mounted to the floor on the opposite side of the panel. The entire process can then be repeated multiple times in order to create a walled enclosure.

In at least one embodiment, an anchor is provided which has been mounted into a floor or flat platform. A metal post is then attached to an anchor mounted in the floor or flat platform. A panel is provided wherein the panel is attached to an appendage on the metal post attached to the anchor. This step is repeated with a second metal post attached to an anchor mounted to the floor on the opposite side of the panel. A second panel is provided wherein the panel is attached to an appendage on a metal post on the walled enclosure. The second panel is then attached to an appendage on a metal post wherein the post may comprise a footer but may not be attached to the floor. A second panel is provided where the panel is attached to an appendage on a metal post on the walled enclosure. The second panel is then attached to an appendage on a metal post wherein the post has a footer but is not attached to the floor. A third panel is provided wherein the panel is attached to an appendage on a metal post on the walled enclosure. The third panel is then attached to an appendage on a metal post wherein the post has a footer but is not attached to the floor. A gate panel is then attached to one of the posts at the front of the kennel enclosure and a gate is attached to the gate panel. A stabilization bar attached above the gate to the each of the two posts at the front of the enclosure and a second stabilization bar is attached at the base of each post below the gate at the front of the enclosure. This method can be repeated multiple times to create a row of kennel enclosures attached to the walled enclosure.

It is an embodiment, to provide a method of configuring a kennel comprising providing a first kennel comprising at least three panels, at least four posts, at least one gate panel, at least one gate, and at least two stabilization bars. The method comprises providing a first panel that is attached to a first post wherein the first post is not attached to the floor. The first panel is then attached to a second post wherein the second post is not attached to the floor. A second panel is then attached to a third post and a fourth post. Finally, a third panel is attached to the second post and the third post, thereby creating a first kennel enclosure with an opening at the front of the enclosure. A gate panel is then attached to the first post at the front of the enclosure and two stabilization bars are attached to the first post and the fourth post above the gate and at the base of the posts. The method then provides for a second kennel enclosure to be attached to the first kennel enclosure where a fourth panel is attached to the second post of the first kennel enclosure and attaching the fourth panel to a fifth post. A fifth panel is then attached to the fourth post and attached to a sixth post, thereby creating a second kennel enclosure. A gate panel is attached to the fifth post in the second kennel enclosure and a gate is attached to the gate panel. Finally, two stabilization bars are attached to the fifth post and the sixth post above the gate and at the base of the posts. The method of kennel configuration provides that the at least one kennel enclosure is erected and used 12 to 16 hours per day and the enclosed facility without at least one kennel enclosure is used 10 to 14 hours per day.

It is an embodiment of the present invention to provide a method of configuring a kennel comprising providing a first kennel comprising at least three panels, at least four posts, at least one gate panel, at least one gate, at least one gate and at least two stabilization bars. The method comprises attaching a first panel to a first post which is not attached to the floor. The panel is then attached to a second post that is not attached to the floor. A second panel is then attached to a third post and a fourth post, wherein both posts are not attached to the floor. Finally, a third panel is attached to the second post and then attached to the third post, thereby creating a first kennel enclosure with an opening at the front of the enclosure. A gate panel is then attached to the first post at the front of the enclosure and a gate is attached to the gate panel. Two stabilization bars are attached to the first post and the fourth post above the gate as well as at the base of the posts. The method then provides for a second kennel enclosure to be attached to the first kennel enclosure wherein a fourth panel is attached to a fifth post and attaching the fourth panel to a sixth post, wherein both posts are not attached to the floor. A fifth panel is then attached to the sixth post and attached to a second post of the first kennel enclosure, thereby creating a second kennel enclosure. A gate panel is attached to the fifth post in the second kennel enclosure and a gate is attached to the gate panel. Finally, two stabilization bars are attached to the first post and the sixth post. The method of kennel configuration provides that at least one kennel enclosure is erected and used 12 to 16 hours per day and the enclosed facility without at least one kennel enclosure is used 10 to 14 hours per day.

In at least one embodiment, a dynamic kennel system is provided that advantageously provides the ability to remove temporary walls in a kennel, thereby providing for a more efficient way to clean or perform maintenance on the floor, which will assist in maintaining sanitary conditions in the kennel area.

In at least one embodiment, an enclosure is provided comprising one or two existing barriers, two or three movable members (one of which includes a gate), one or more pins, one or more hinges and one or more permanent posts. The enclosure is configured as a temporary kennel area wherein one or two adjacent sides are pre-existing barriers and the other two or three adjacent sides are movable between collapsed and expanded positions. Accordingly, when fully expanded, the temporary kennel system is used to create separate spaces suitable for housing at least one animal, such as a dog.

When not in use, the collapsible sides may be folded on hinges and stored in an upright and flattened position, which is located next to one of the pre-existing barriers. That is, the hinged sides of the dynamic kennel system are pushed back against one of the pre-existing barriers, thereby allowing most of the area with the dynamic kennel system to be used for another purpose, such as a play area. In at least one embodiment, the collapsible sides have plastic glides located at the bottom side of the movable members near the corners and are designed to assist with movement of the collapsible sides, thereby reducing the stress on the hinges caused by the weight and movement of the collapsible sides.

In at least one embodiment, a dynamic kennel system appropriate for use at a corner formed by two pre-existing barriers is provided. Examples of the pre-existing barriers include, but are not limited to, an existing wall, a fence, or a portion of a permanent kennel. In at least one embodiment, one of the pre-existing barriers is fitted with a permanent kennel post that is used to attach to one of the collapsible kennel sides. Without intending to be limiting, a hinge plate and eyebolts may be used to interconnect a side panel of the collapsible kennel to the permanent kennel post. In at least one embodiment, the side panel comprises a first material, such as a plastic sheet, contained in a frame made of a second material different than the first material. The second material may be a material having stiffer engineering properties than the first material. By way of example and not limitation, the second material may include one or more of a stiffer plastic, metal or metal alloy (e.g., aluminum or aluminum alloy), wood, carbon fiber, and fiberglass. The opposite end of the side panel may contain a butt hinge, which is also attached to the front gate of the kennel. The butt hinge is used to fold the panel containing the front gate section of the kennel next to the collapsible side wall of the kennel to the opposite side of the collapsible side wall from attached existing barrier.

To utilize the temporary kennel, a user unfolds the two temporary walls along the hinges bringing them into place to create a useable kennel area. There are plastic glides located near the corners on the bottom side of the collapsible walls to assist with engaging the kennel enclosure into the open/engaged or closed/storage positions. More particularly, gliders may be located at the bottom side of the front panel and on the bottom side of the side panel located on the side opposite the hinge plate, near where it connects with the front panel. The gliders are used to assist the operator in opening and closing the temporary kennel enclosure by creating a surface with less friction to move across the flooring surface. The glides may also be used to distribute the weight of the front and side panels, so that the full weight of the panels is not absorbed by the hinge plate. Additionally, the glides are used to assist in aligning the protruding pins from the front panel section with the receiving holes in the adjustment bar.

In at least one embodiment, the front gate of a dynamic kennel is a plastic sheet associated with a structural element, such as being connected to an aluminum or aluminum alloy frame. The side of the aluminum or aluminum alloy frame opposite the side containing the butt hinge contains protruding pins which are inserted into holes located in a bar that is attached to a pre-existing barrier. The pins, which protrude from the frame, act as guides to line up the temporary kennel wall or gate with the pre-existing wall or adjacent portion of a dynamic kennel. The pins are also able to absorb at least a portion of the stress that an enclosed dog might exert on the kennel enclosure, such as by digging at it or jumping against it. Once the protruding pins are placed in the corresponding holes in the bar, rotary latches located on the front panel are engaged to secure the frame into place.

Various components are referred to herein as “operably associated.” As used herein, “operably associated” refers to components that are linked together in operable fashion, and encompasses embodiments in which components are linked directly, as well as embodiments in which additional components are placed between the two linked components.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a top view of an enclosure facility showing a layout of anchors placed into the floor, without panels and posts in place of one embodiment of the present invention;

FIG. 2 is a perspective of the metal posts of the system, including the appendages on each face of the post of one embodiment of the present invention;

FIG. 3 is a perspective of a footer or platform of an embodiment of one or more present inventions of one embodiment of the present invention;

FIG. 4 is a perspective of a footer or platform of an embodiment attached to a post of one embodiment of the present invention;

FIG. 5 is a perspective showing one arrangement of the panels and posts creating a walled enclosure as well as the entrance into the walled enclosure;

FIG. 6 is a perspective showing a second arrangement of panels and posts;

FIG. 7 is a perspective of one example of the front view of a gate of the system;

FIG. 8 is a view of the kennel enclosure showing the four posts with four footers on each post, three panels attached to the appendages on the four posts, a gate panel and gate, and two stabilizer bars at the entrance of the enclosure;

FIG. 9 is a flow diagram showing the steps for setting up a kennel enclosure with a gate;

FIG. 10 is a perspective of the entire kennel configuration system with the posts and panels;

FIG. 11 is another perspective of the entire kennel configuration system with the posts and panels;

FIG. 12 is a flow diagram showing the step for setting up rows of multiple kennel enclosures in the enclosed facility;

FIG. 13 is another perspective of the entire kennel configuration system with the posts and panels;

FIG. 14 is another perspective of the entire kennel configuration system with the posts and panels;

FIG. 15 is another perspective of the entire kennel configuration system with the posts and panels;

FIG. 16 is an elevation view of a gate for the four-way gate system as shown form the front, back, top, bottom, and side;

FIG. 17 is an elevation view of a walled enclosure panel as shown form the front, back, top, bottom, and side;

FIG. 18 is another perspective of the kennel configuration system;

FIG. 19 is a perspective of the four-way gate system showing the four posts and four gates of the system;

FIG. 20 is a perspective of the four-way gate system showing the four posts and four gates of the system;

FIG. 21 is another perspective of the four-way gate system showing the four posts and four gates of the system;

FIG. 22 is four diagrams showing the different positions of the four-way gate system of one embodiment of the present invention;

FIG. 23 is a perspective of two gates of four-way gate system;

FIG. 24 shows a diagram showing the floor plan of a kennel facility and showing the integration of the dynamic kennel system and method in the kennel facility;

FIG. 25 is a perspective of stabilizer bar and wing of one embodiment of the present invention;

FIG. 26 is a top plan view of an embodiment of a dynamic kennel system showing the layout of the pre-existing barriers and additional members for one unit;

FIG. 27 is a top plan view of the dynamic kennel configuration showing the layout of the two temporary walls in place in one embodiment of the present invention;

FIG. 28 is a top plan view of the dynamic kennel configuration showing the layout of the pre-existing barriers and temporary walls while collapsed for one unit in one embodiment of the present invention;

FIG. 29 is a side elevation view of one example of the side panel for the dynamic kennel;

FIG. 30 is a front elevation view of one example of the front view of a gate of the dynamic kennel system;

FIG. 31 is a top plan view of the dynamic kennel configuration showing the layout of the pre-existing barriers and temporary walls in place for multiple units in one embodiment of the present invention;

FIG. 32 is a top plan view of the dynamic kennel configuration showing the layout of the temporary walls while collapsed for multiple units in one embodiment of the present invention;

FIG. 33 is a front perspective view of the frame for the kennel gate;

FIG. 34 is a top plan view providing an example of a dog kennel facility with the collapsible kennels 2600 engaged and in use; and Table 1 shows the usage of an enclosed facility over a 24-hour period.

### DETAILED DESCRIPTION

Multiple embodiments of one or more inventions described herein successfully overcome the shortcomings of the presently known kennel systems and methods for configuring kennels by providing a kennel facility to be used for multiple purposes including as a play area for animals or as a kennel area for animals to rest or sleep. Specifically, one or more embodiments of the system of one or more inventions provide an enclosed facility with an area that allows for animals to exercise which can be modified to an enclosed kennel facility wherein interchangeable posts, panels and gates are erected to provide kennel enclosures for animals to rest and sleep. The posts, panels and gates of the kennel enclosures can then be quickly disassembled and removed from the area to allow animals an unencumbered recreation area. One or more embodiments provide the ability for the enclosed facility to be used as a recreation area for 10 to 14 hours per day while also be being used to hold kennel enclosures 12 to 16 hours per day.

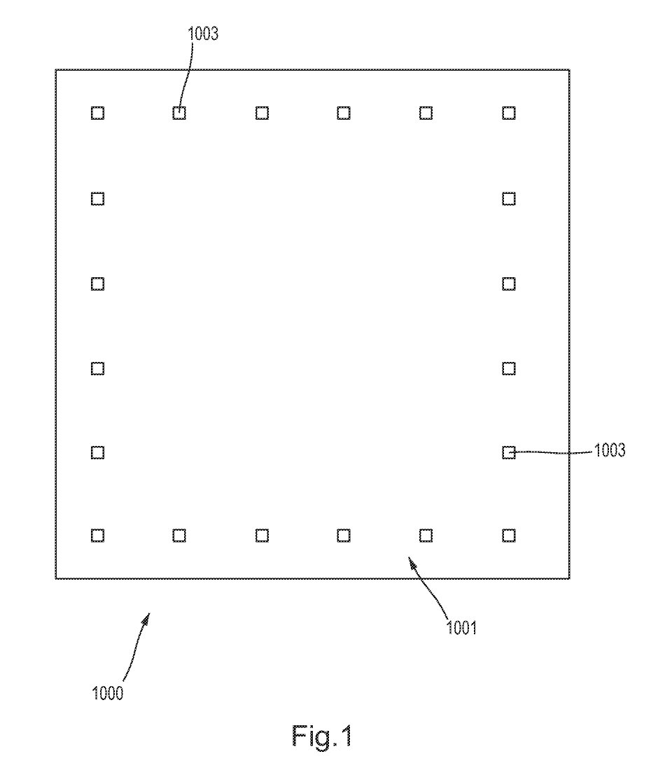

At least one embodiment of the one or more present inventions provides a floor in an enclosed facility where anchors have been placed in the floor. Referring to FIG. 1, an embodiment of one or more present inventions, 1000 is shown. As shown in FIG. 1, at 1001 a floor is provided. By way of example and not limitation, as shown in FIG. 1, 1003, standard concrete anchors are placed in the floor to allow for posts to be bolted to the floor.

At least one embodiment of the one or more present inventions provides a post for the attachment of panels. The post may be made of wood, plastic, metal another material, however, one embodiment may comprise aluminum. The post is a square tube, six foot lengths (6.0°) and 2.5 inches wide. The posts include four 1.5 inch appendages that are forged to the tube, one appendage on each side of the tube. Each appendage or wing has a plurality of openings formed through the appendage or wing. A stamped metal foot may be attached to the base of each post which may allow the post to be attached to anchors in the floor of the facility or to simply provide a stable platform for the post to stand. The post may be attached to the footer by a variety of means which will be known to those skilled in the art, however, one embodiment may comprise ¼-20 machine bolts.

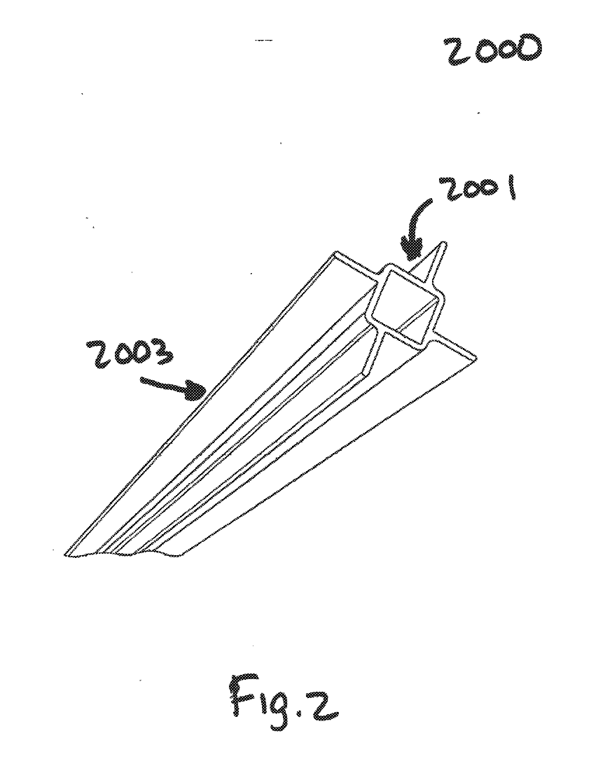

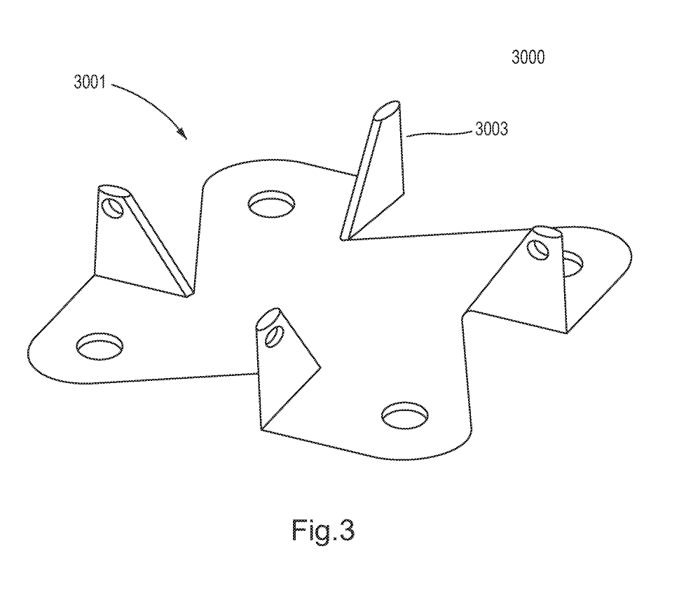

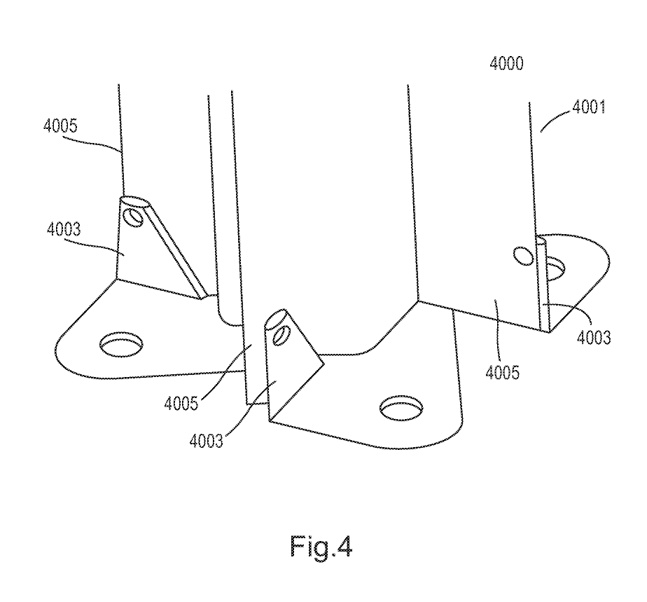

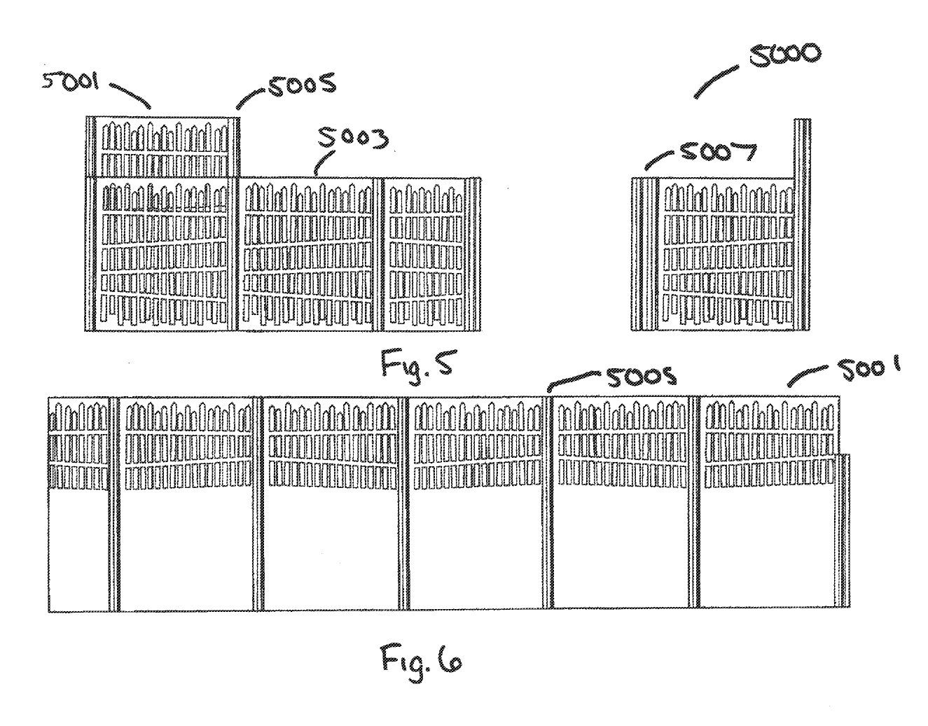

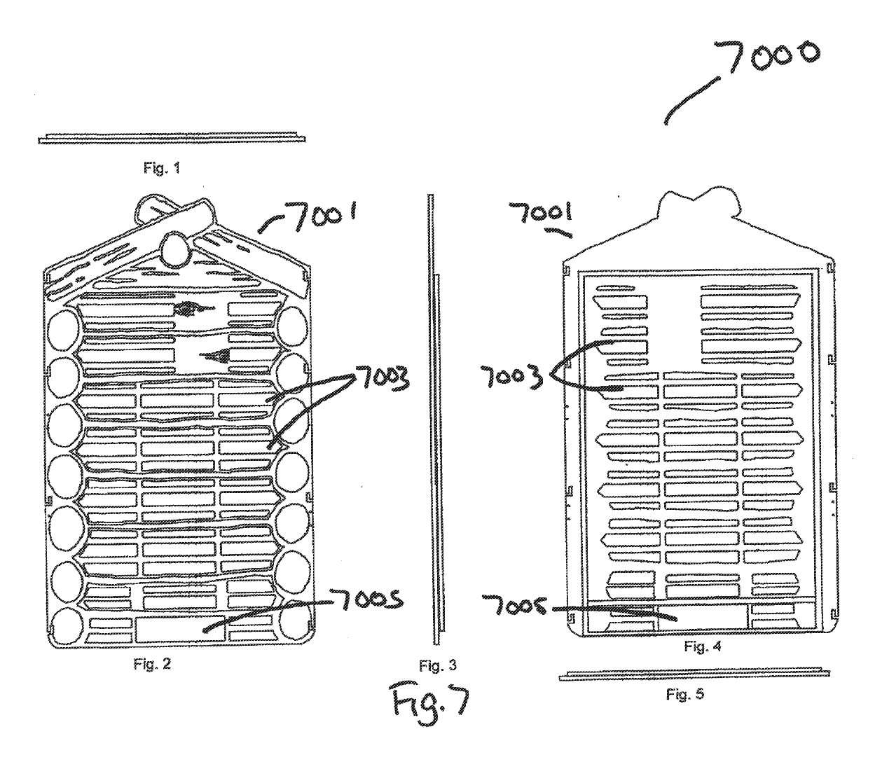

Referring to FIG. 2, a post of an embodiment of one or more present inventions, 2000 is shown. As shown in FIG. 2, at 2001, a four-sided post is provided. Appendages or wings, 1.5″ inches wide and matching the length of the post may be one of coupled and integrated to ea

Referring to FIG. 3, a foot or platform of an embodiment of one or more present inventions, 3000 is shown. As shown in FIG. 3, at 3001, a platform with a flat with holes for attachment to a floor is provided. Appendages or wings, 1.5″ inches wide, with openings cut through the appendages and matching the appendages on the metal post rise from the flat platform at a ninety degree angle, 3003.

Referring to FIG. 4, a foot or platform attached to a post of an embodiment of one or more present inventions, 4000 is shown. As shown in FIG. 4, at 4001, a platform with a flat surface with holes for attachment to a floor is provided. Appendages or wings of the platform, 1.5″ inches wide, with openings cut through the appendages and matching the appendages on the metal post rise from the flat platform at a ninety degree angle, 4003. Appendages or wings of the post, 1.5″ inches wide, with openings cut through the appendages and matching the appendages on the platform are also shown, 4005.

At least one embodiment of the one or more present inventions provides at least one panel. The panel may be provided in a variety of sizes, however, the one size for the system 4.0°×6.0° and 0.5″ for the panels that will be used for kennel enclosures and 4.0°×4.0°×0.5″ for outer panels that will be used on the walled enclosure of the facility. Each panel may be made of metal, plastic, wood or other materials although the one embodiment may comprise high density polyethylene (HDPE). Both the kennel panels and panels of the walled enclosure have ventilation holes cut through the panel to allow for the movement of air, the ventilation holes may be established in the upper half of the inner panel with the lower half of the panel remaining solid to allow for addition privacy within the kennel enclosures. The side of each panel may be attached to an appendage on a post on each side of each panel. The panels may be attached to each post by a variety of means which are known to those skilled in the art. One means of attachment may use a plurality of ¼-20 machine bolts.

Referring to FIG. 5, the kennel panels and panels for one walled enclosure 5000 are shown and illustrated. As shown in FIG. 5, at 5001, a 4.0′×6.0° kennel panel is provided. The kennel panel is 0.5″ thick and may be made from metal, plastic, wood or other materials, with one embodiment comprising high density polyethylene (HDPE). In addition, 4.0°×4.0° walled enclosure panels are shown, 5003. Each side of the panel is attached to an appendage on a post established on each side of the panel, with a post for a kennel panel shown, 5005 and a post for a walled enclosure are shown, 5007.

Referring to FIG. 6, the kennel panels and panels for the walled enclosure 5000 are shown and illustrated. As shown in FIG. 6, at 5001, a 4.0′×6.0° kennel panel is provided. The kennel panel is 0.5″ thick and may be made from metal, plastic, wood or other materials, with one embodiment comprising high density polyethylene (HDPE). Each side of the panel is attached to an appendage on a post established on each side of the panel, with a post for a kennel panel shown, 5005.

At least one embodiment of the one or more present inventions provides at least one gate for the kennel enclosures. The gate may be provided in a variety of sizes. One size for the system comprises a system having dimensions of 4.0° wide and 6.0° at a center apex and tapering on each side of the gate. The gate may be made of metal, plastic, wood or other materials. The gate has ventilation holes cut through the gate to allow for the movement of air into and out of the kennel enclosure. In addition, the gate has an opening or window near the base of the gate to allow for the movement of materials into and out of the kennel enclosure. The window may be used to allow for food and water to be added or removed from the enclosure or may be where an automatic feeder is located. The gate is located at the front of the kennel enclosure and attaches to a gate panel which is attached to an appendage on a post that is placed on either side of the gate. The gate panel may be attached to the appendages by a variety of means which will be known to those skilled in the art. One means of attaching the gate panel to the appendage of an post is by using a plurality of ¼-20 machine bolts.

Referring to FIG. 7, a gate of an embodiment of one or more present inventions, 7000 is illustrated. As shown in FIG. 7, at 7001, the gate has a height of 6.0° at the apex of the height of the gate and then tapers on either side of the gate. The gate has air vents located at various locations on the gate, 7003. In addition, the gate has a window located near the base of the gate, 7005.

In one or more embodiments, two stabilization bars with wings are provided which are attached above the gate and below the gate to an appendage on the inner posts on each side of the gate for added stability. The stabilization bars are attached to each inner post of the kennel at 6.0° and at the base or the inner post. The stabilization bars are 4.0° in length and may be made of wood, metal, plastic or other materials. The stabilization bars and wings may be attached to the appendages by a variety of means which will be known to those skilled in the art. One means of attaching of the stabilization bar to the appendages of each post may be by using a plurality of ¼-20 machine bolts.

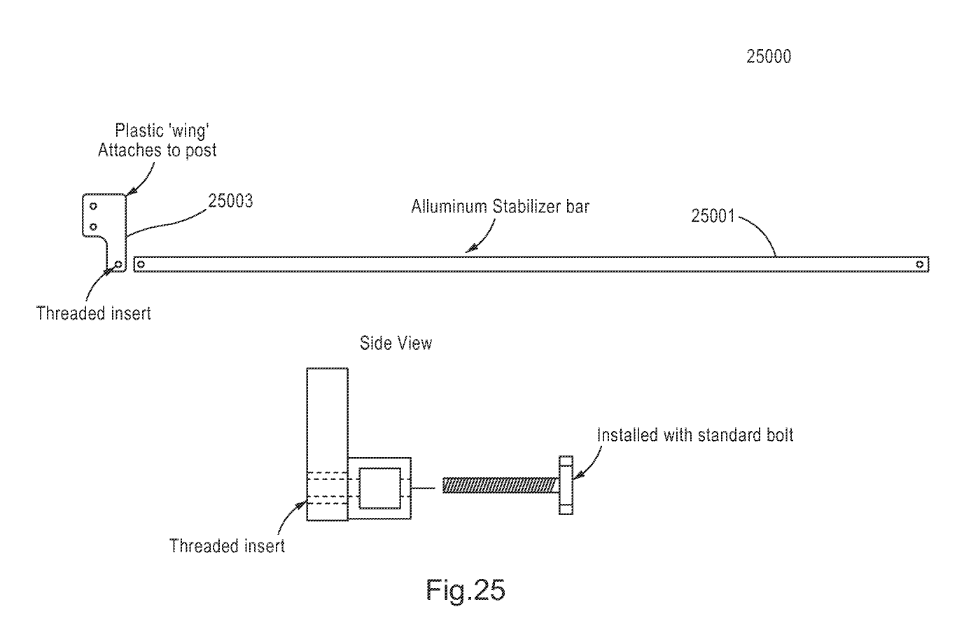

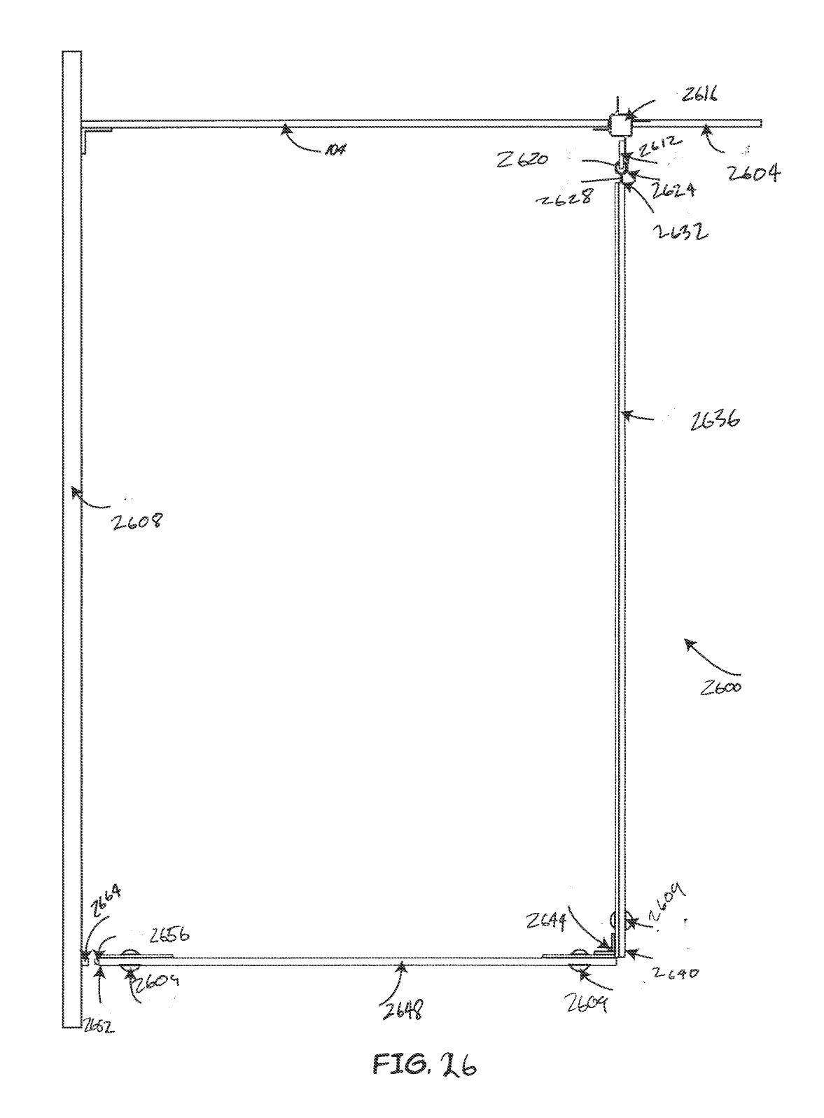

Referring to FIG. 25, a stabilization bar and wing of an embodiment of one or more present inventions, 25000 is illustrated. As shown in FIG. 25, at 25001, the stabilization bar has a length of 4.0°. A plastic wing is attached to a post at the front of the kennel enclosure and one end of the stabilization bar attaches to the wing, 25003. The other end of the stabilization bar then attaches to the second post at the front of the kennel enclosure.

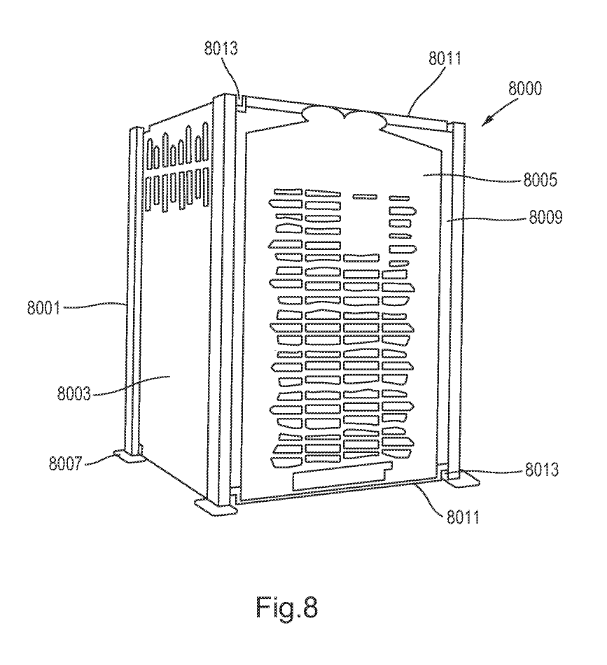

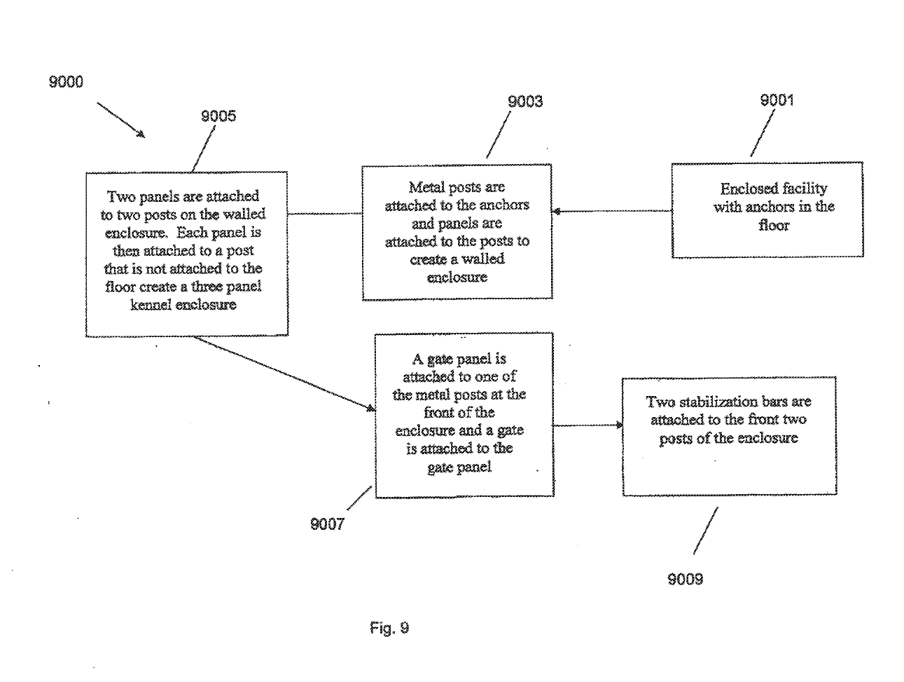

Referring to FIG. 8, an example of a complete kennel enclosure is shown, 8000. As shown in FIG. 8, at 8001, two back posts are provided which will usually attached to a footer, 8007. Three kennel panels are provided, 8011, which are attached to a post positioned on each side of the panel. A gate panel, 8009, is attached to a post at the front of the kennel enclosure and a gate, 8005, is then attached to the gate panel. A stabilization bar, 8011 is attached to the posts at the front of the kennel enclosure by attaching a plastic wing, 8013, to a post on one side of the front of the kennel enclosure, attaching one end of the stabilization bar to the wing and the other end of the stabilization bar to a post on the other side of the entrance of the kennel enclosure.

At least one embodiment of the one or more present inventions provides a kennel enclosure system which includes a floor with anchors in the floor, posts, kennel panels, walled enclosure panels, a gate panel, a gate and two stabilization bars configured together to create a kennel enclosure. Anchors are permanently placed in a floor or platform and arranged in the floor or platform to allow posts to be attached to each anchor and then panels attached to each post to create a walled enclosure. Each panel and post of the walled enclosure may then be used as the back panel and back posts of a kennel enclosure. Two kennel panels are attached to an appendage on two posts of the walled enclosure. Each kennel panel is then also attached to a post on the opposite side of the panel. The second post may have an anchor attached to the base of the post for stability. However, the second post and anchor are not permanently attached to the floor or platform. The 6.0°×4.0° kennel panels will be used for kennel enclosures that will house animals. The gate panel is then attached to the front of the enclosure by attaching one side of the gate panel to an appendage on one of the posts at the front of the enclosure. A gate is then attached to the gate panel. Two stabilization bars with wings are attached to an appendage on each of the two posts on each side of the gate and gate panel with one bar attached above the gate and one bar attached at the base of each post. Additional kennel enclosures may be established by using another panel and post on the walled enclosure and attaching an additional panel to the post of the walled enclosure and a second post attached to the opposite side of the new kennel panel. The new post may have an anchor or foot attached to the base of the post however, the post and anchor will not be permanently attached to the floor or platform. A gate panel will then be attached to the new front post of the new enclosure and a gate attached to the new gate panel. Two stabilization bars with wings will then be attached to the post at the front of the first enclosure and the new post at the front of the new enclosure where one stabilization bar and wing is attached above the gate and a second stabilization bar is attached at the base of each of the front posts. A row of multiple kennel enclosures can then be erected in this fashion.

Referring to FIG. 9, a flow diagram depicting one or more inventions illustrating a method of configuring a kennel enclosure, 9000, is shown. As shown in FIG. 9, anchors are attached to a floor or platform 9001, posts are attached to each anchor and panels are attached to each post to create a walled enclosure, 9003. The walled enclosure may be used as a play or recreation area and then transformed into a kennel area by using one of the panels of the walled enclosure and attaching two panels to two posts of the walled enclosure with the two panels also attached to two posts which are placed at the front of the enclosure, 9005. A gate panel is then attached to an inner post at the front of the enclosure by attaching the gate panel to an appendage or wing on one of the inner posts at the front of the enclosure and a gate is then attached to the gate panel, 9007. Finally, two stabilization bars are attached to the two posts at the front of the enclosure with one bar attached above or at an upper portion of the gate and the second bar placed at the base of the posts, 9009.

At least one embodiment of the one or more present inventions provides multiple kennel enclosures. It is an embodiment of the present invention to provide a facility with anchors placed into the floor, panels, posts, gate panels, gates and stabilization bars configured together to create multiple kennel enclosures. Anchors are placed in the floor or a platform. Posts are then attached to each anchor and panels attached to the posts to create a walled enclosure. Each panel is attached to an appendage on the side of each post. A panel on the walled enclosure may then be used as the back panel of a kennel enclosure to create a 4.0° deep×4.0° wide kennel enclosure. Two panels are attached to posts on the walled enclosure and then attached to posts that are placed at the front of the kennel enclosure which can then allow for multiple kennel enclosures to be created by simply adding a new panel and post to the next post along the walled kennel enclosure. A gate panel is attached to the front of each kennel enclosure by attaching the gate panel to an appendage on one of the posts at the front of each enclosure. A gate is then attached to the gate panel. Two stabilization bars are attached to appendages on each of the two posts on each side of the gates at the front of each enclosure with one bar attached above the gate and a second bar attached at the base of each front post. Each additional kennel enclosure may be established by attaching an additional panel to the first kennel enclosure by attaching the panel to the next post on the walled enclosure and using the next panel on the walled enclosure. A gate panel is then attached to the new posts at the front of each new enclosure and a gate attached to the gate panel. Finally, a stabilization bar is attached to the posts at the front of each enclosure.

In another embodiment of one or more present inventions, an additional method for establishing additional kennel enclosures includes providing a kennel enclosure that is not attached to a walled enclosure. Additional kennel enclosures can then be added by attaching a new panel to an appendage on a post at the rear of the first kennel enclosure. The new inner panel is then attached to a second post placed 4.0° from the first enclosure. A second inner panel is then attached to the second inner post and attached to a new post placed 4.0° from the front inner post of the first enclosure, creating a new three panel enclosure that is 4.0° deep×4.0° wide. A new gate panel is then attached to a front inner post of the new enclosure with a gate then attached to the gate panel. Two stabilization bars are attached to the inner post at the front of the first enclosure and the new inner post at the front of the new enclosure. A row of multiple kennel enclosures can then be erected in this fashion.

In another embodiment of one or more present inventions, an additional method for establishing additional kennel enclosures includes providing a kennel enclosure that is not attached to a walled enclosure. Additional kennel enclosures can then be added by providing a new kennel panel attached to an appendage on a post at the rear of the first kennel enclosure. The new kennel panel is then attached to a second post placed 4.0° from the first enclosure. A second kennel panel is then attached to the second rear post and attached to a new post placed 4.0° from the rear post of the first enclosure, creating a new three panel enclosure that is 4.0° deep×4.0° wide. A new gate panel is then attached to a front post of the new enclosure with a gate attached to the new gate panel. Two stabilization bars are attached to the two posts at the front of the new enclosure. A row of multiple kennel enclosures can then be erected in this fashion.

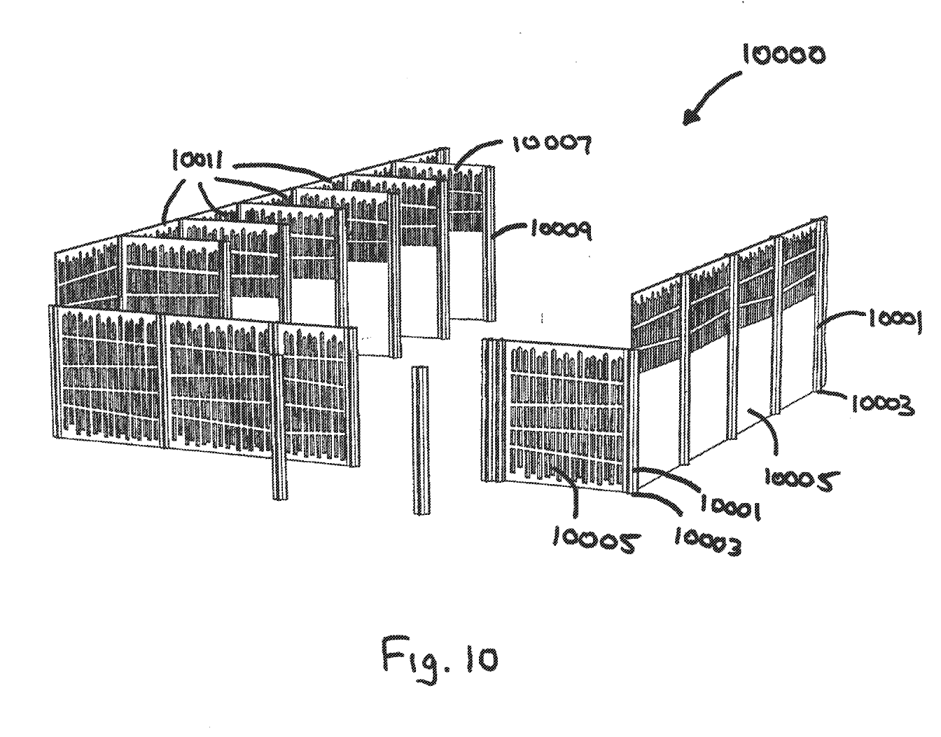

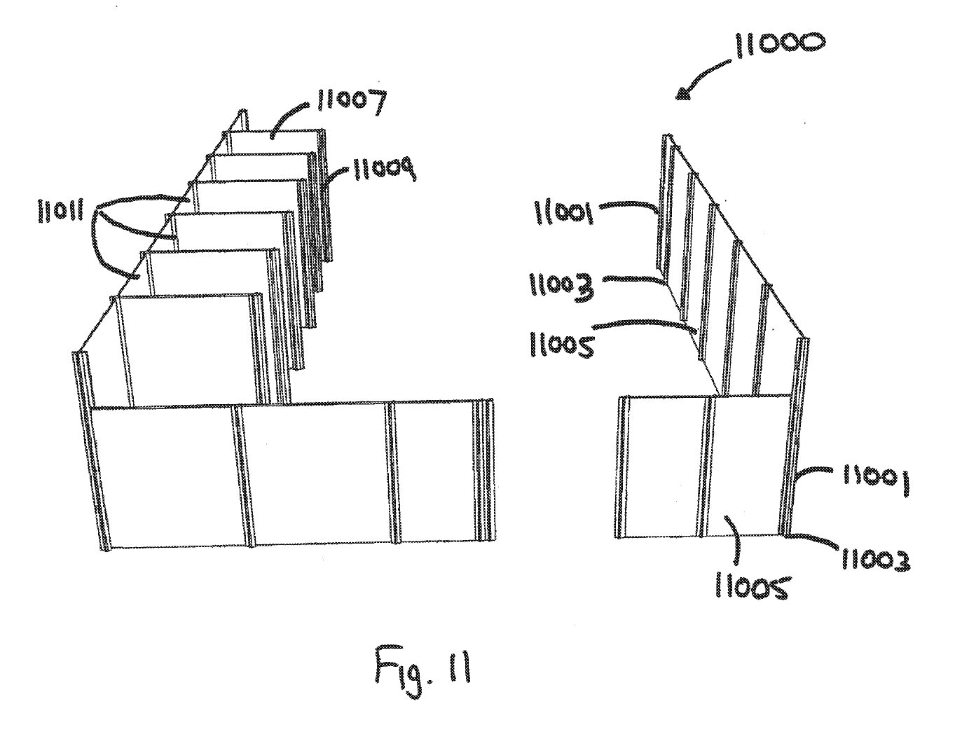

Referring to FIG. 10, an embodiment of one or more inventions illustrating multiple kennel enclosures 10000 is shown. As shown in FIG. 10, at 10001, posts are attached to anchors in the floor of the facility, 10003. Panels are attached to the posts to create a walled kennel enclosure, 10005. Kennel panels are attached to posts on the walled enclosure, 10007, and the kennel panels are then attached to posts placed at the front of the kennel enclosures, 10009. Multiple rows of kennel enclosures are also shown, 10011.

Referring to FIG. 11, an embodiment of one or more inventions illustrating multiple kennel enclosures, 11000 is shown. As shown in FIG. 11, at 11001, posts are attached to anchors in the floor of the facility, 11003. Panels are attached to the posts to create a walled kennel enclosure, 11005. Kennel panels are attached to posts on the walled enclosure, 11007, and the kennel panels are then attached to posts placed at the front of the kennel enclosures, 11009. Multiple rows of kennel enclosures are also shown, 11011.

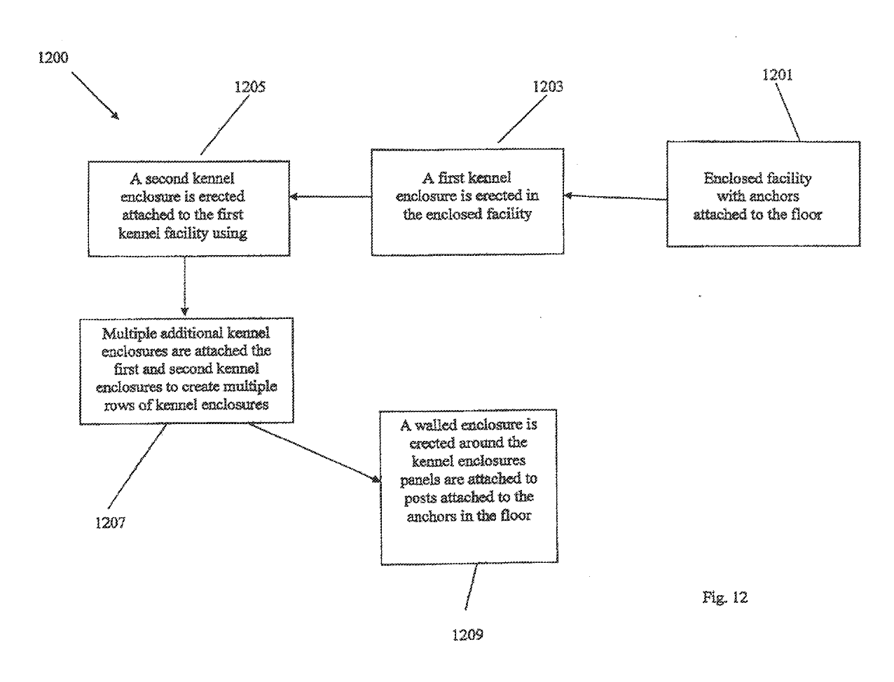

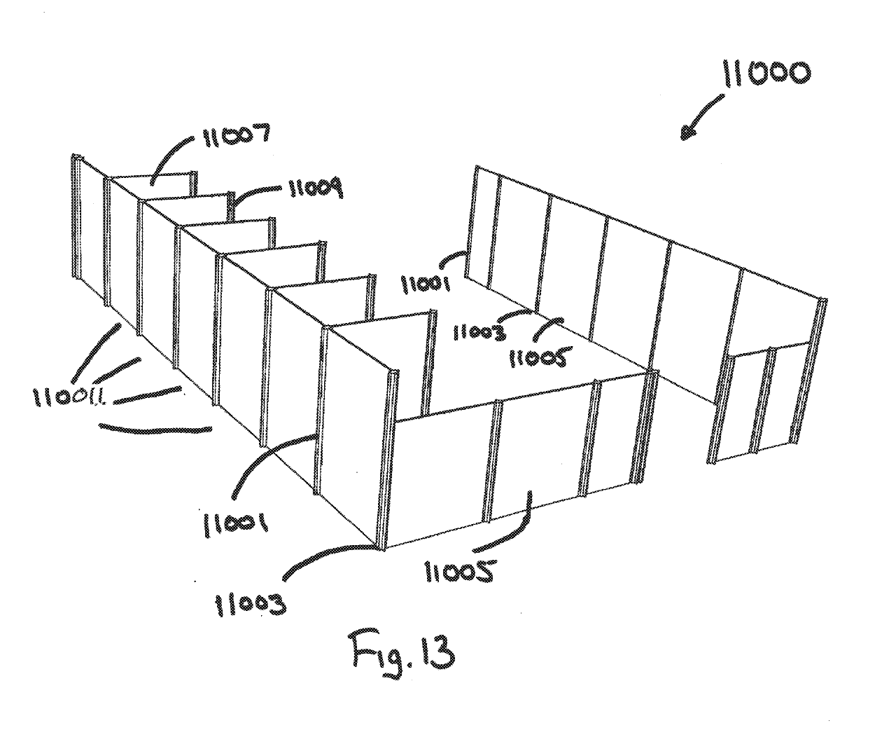

FIG. 12, a flow diagram depicting one or more inventions illustrating a method of configuring multiple kennel enclosures, 12000, is shown. The method comprises starting with an enclosed facility with an open area, where the facility has a floor with anchors placed in the floor, 12001. A first kennel enclosure is erected in the facility, 12003. Next, a second kennel enclosure is erected that is attached to the first kennel enclosure, 12005. Multiple kennel enclosures are erected that are attached to the first and second kennel enclosures, thereby creating multiple rows of kennel enclosures, 12007. Finally, an outer wall is erected around the kennel enclosures, 12009.

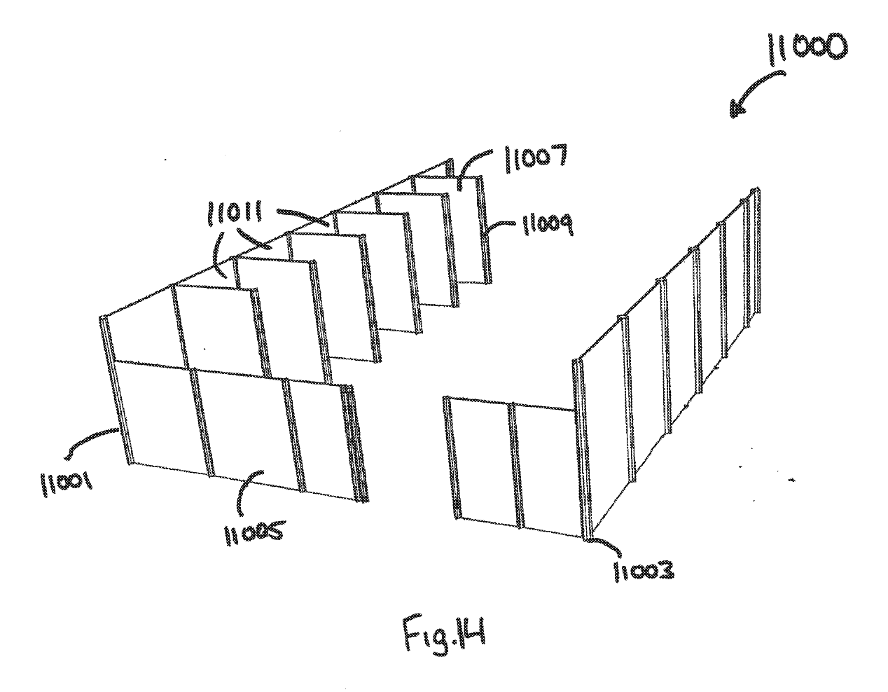

Referring to FIG. 13, an embodiment of one or more inventions illustrating multiple kennel enclosures, 11000 are shown. As shown in FIG. 11, at 11001, posts are attached to anchors in the floor of the facility, 11003. Panels are attached to the posts to create a walled kennel enclosure, 11005. Kennel panels are attached to posts on the walled enclosure, 11007, and the kennel panels are then attached to posts placed at the front of the kennel enclosures, 11009. Multiple rows of kennel enclosures are also shown, 11011.

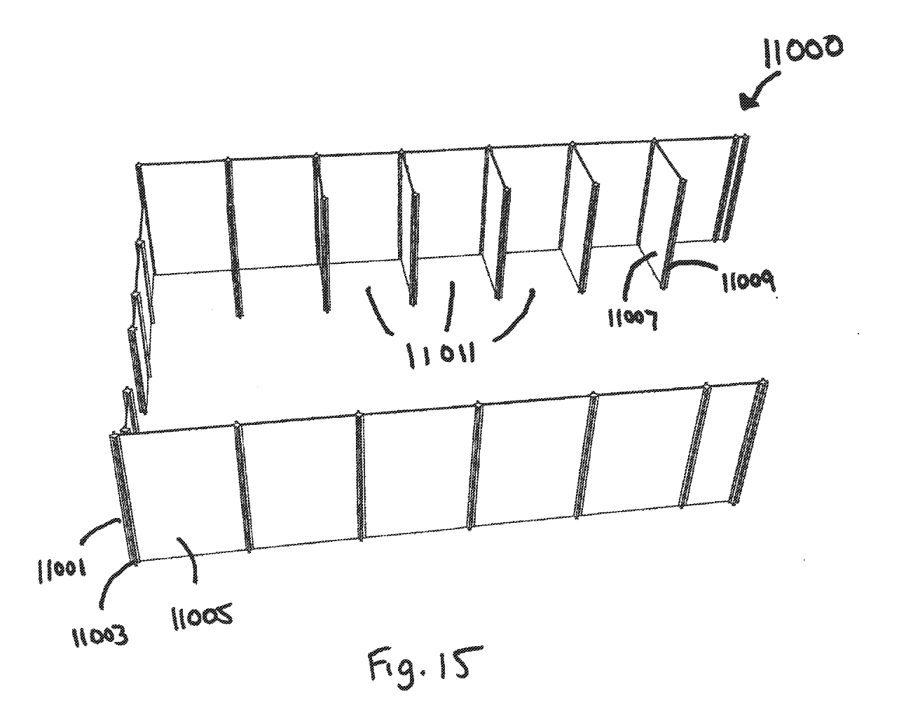

Referring to FIG. 14, an embodiment of one or more inventions illustrating multiple kennel enclosures, 11000 are shown. As shown in FIG. 11, at 11001, posts are attached to anchors in the floor of the facility, 11003. Panels are attached to the posts to create a walled kennel enclosure, 11005. Kennel panels are attached to posts on the walled enclosure, 11007, and the kennel panels are then attached to posts placed at the front of the kennel enclosures, 11009. Multiple rows of kennel enclosures are also shown, 11011.

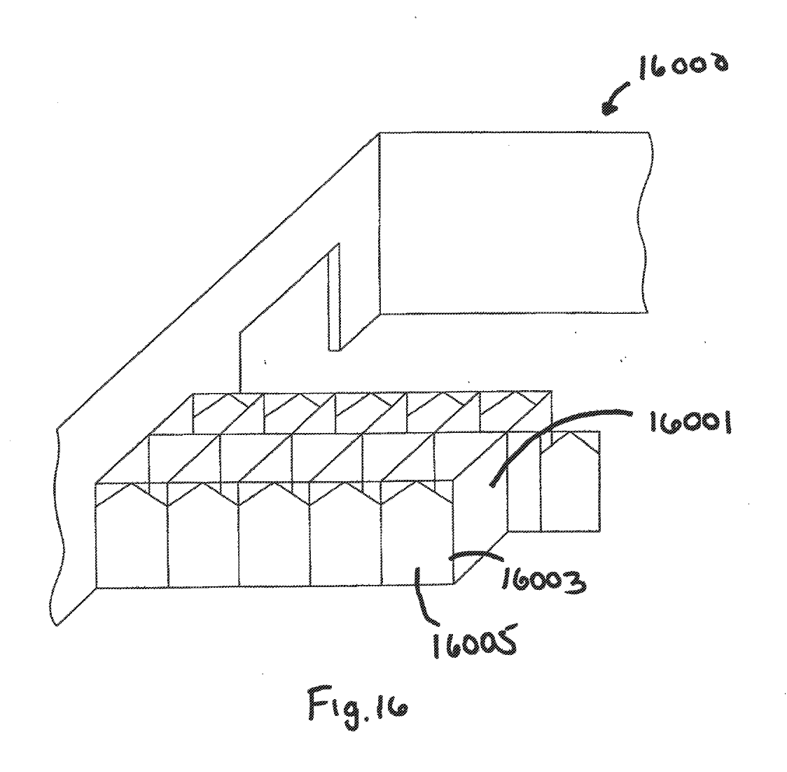

Referring to FIG. 15, an embodiment of one or more inventions illustrating multiple kennel enclosures, 11000 are shown. As shown in FIG. 11, at 11001, posts are attached to anchors in the floor of the facility, 11003. Panels are attached to the posts to create a walled kennel enclosure, 11005. Kennel panels are attached to posts on the walled enclosure, 11007, and the kennel panels are then attached to posts placed at the front of the kennel enclosures, 11009. Multiple rows of kennel enclosures are also shown, 11011.

Referring to FIG. 16, an embodiment of one or more inventions illustrating multiple kennel enclosures as used without a walled enclosure, 16000 is shown. As shown in FIG. 16, at 16001, panels are attached to create posts to create multiple inner kennel enclosures, 16003. Gates are then attached to the posts at the front of each enclosure, 16005.

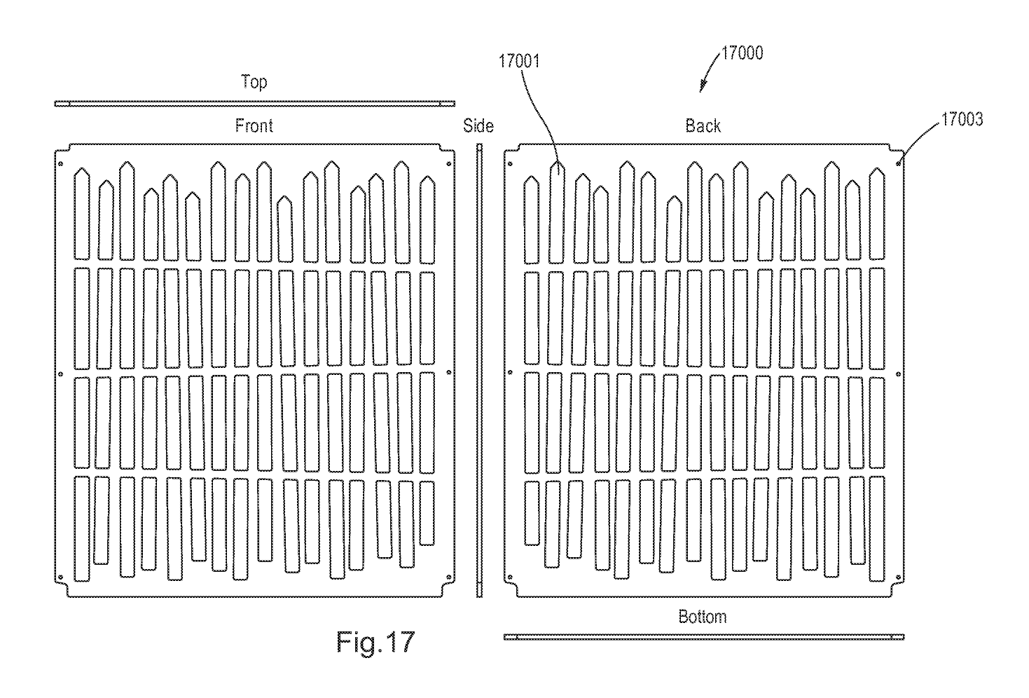

Referring to FIG. 17, an example of a panel for the walled enclosure of an embodiment of one or more inventions, 17000, is shown. As shown in FIG. 17, at 17001, the panel for the walled enclosure has cut outs throughout the panel. The panel also has holes along the side of the panel to allow for the attachment of the panel to the posts of the invention.

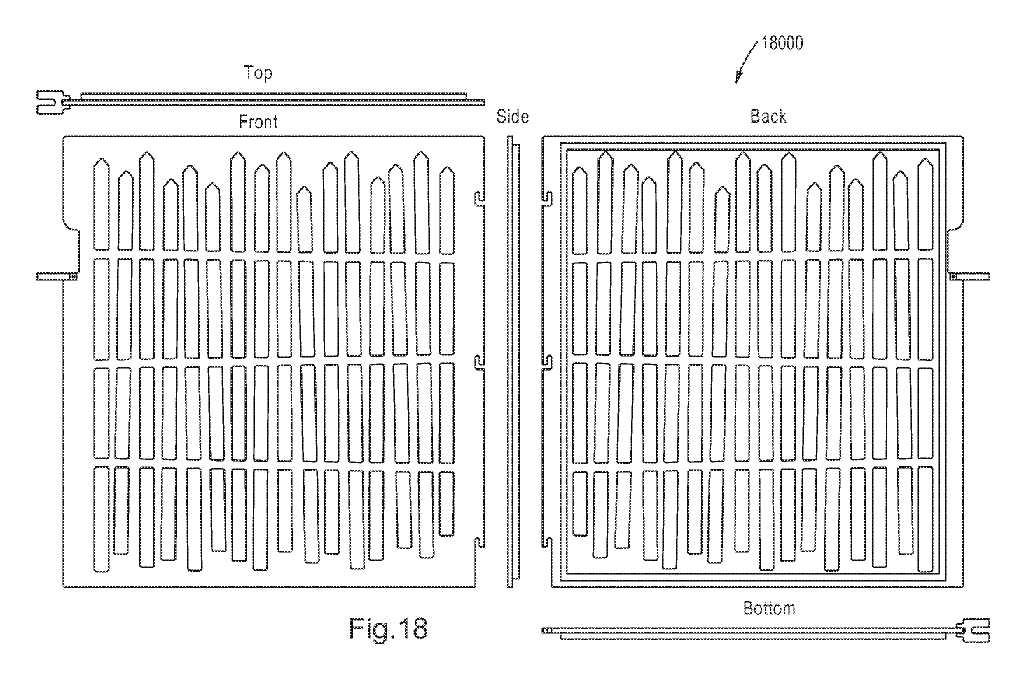

At least one embodiment of one or present inventions provides a four-way gate. The four-way gate uses four posts attached to anchors placed in the floor of a facility. The posts are established at the corners of a 4.0° deep×4.0° long pattern and each of the four gates are attached to gate panels which are attached to appendages on each of the four posts. Each gate will open in two directions to allow an individual to access to four separate areas while also limiting the ability of movement from one area to the next. Referring to FIG. 18, an example of a gate used in the four-way gate system, 18000, is shown.

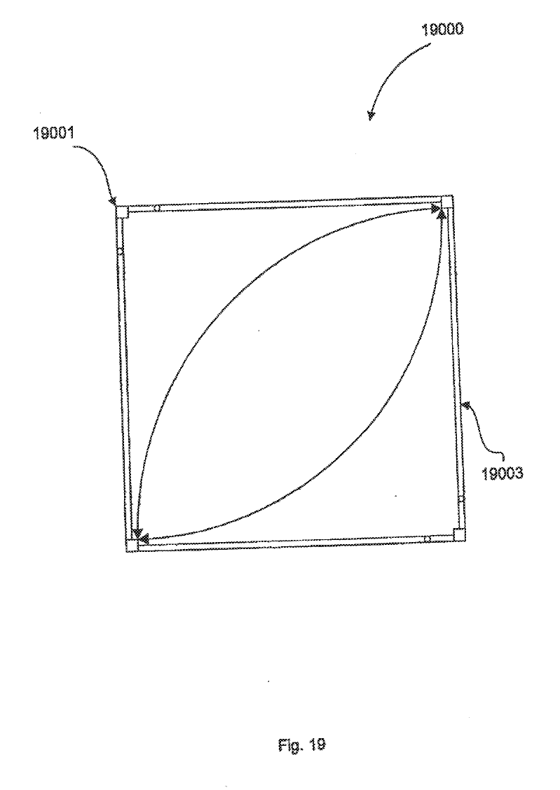

Referring to FIG. 19, an embodiment of a four-way gate, 19000 is shown. As shown in FIG. 19, at 19001, four posts are placed in a 4.0°×4.0° square pattern and attached to anchors in the floor. Each gate is then attached to a gate panel which is attached to an appendage on each post, 19003.

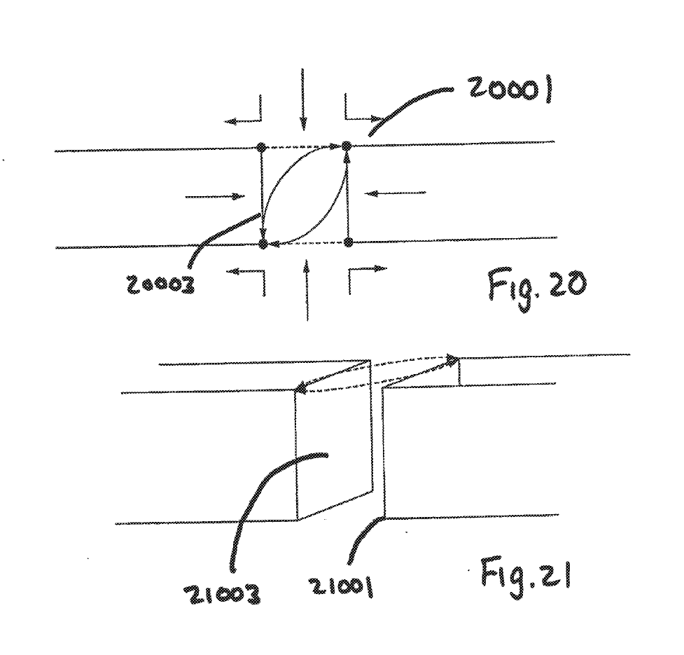

Referring to FIG. 20, an embodiment of a four-way gate, 20000 is shown in another perspective. As shown in FIG. 20, at 20001, four posts are placed in a 4.0°×4.0° square pattern and attached to anchors in the floor of the facility. A gate is then attached to a gate panel which is attached to an appendage on each post, 20003.

Referring to FIG. 21, an embodiment of a four-way gate, 21000 is shown. As shown in FIG. 21, at 21001, four posts are placed in a 4.0°×4.0° square pattern and attached to anchors in the floor of the facility. A gate is then attached to a gate panel which is attached to an appendage on each post, 21003.

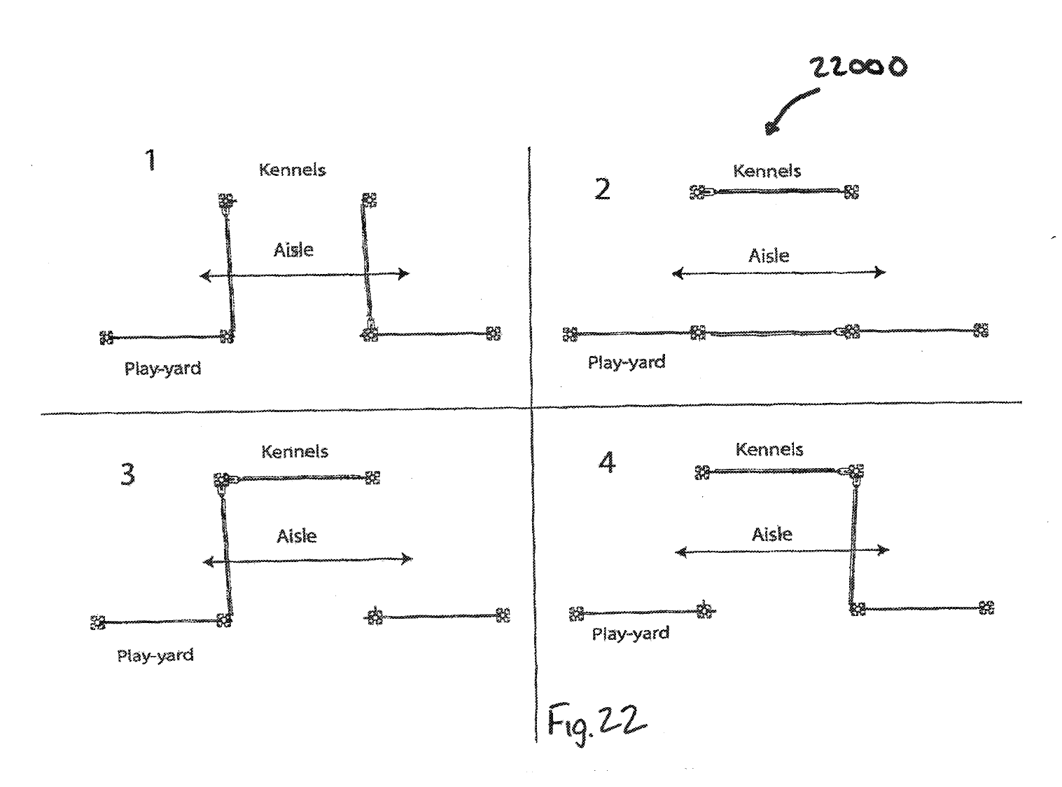

Referring to FIG. 22, four diagrams are provided showing several different positions of the four-way gate system, 22000. As shown in diagrams 1, 2, 3 and 4, four posts are provided where gate panels are attached to each post which allows the gates of the invention to be attached to each post. The gates can then swing in two directions to multiple aisles of movements through the gates into different areas of a facility.

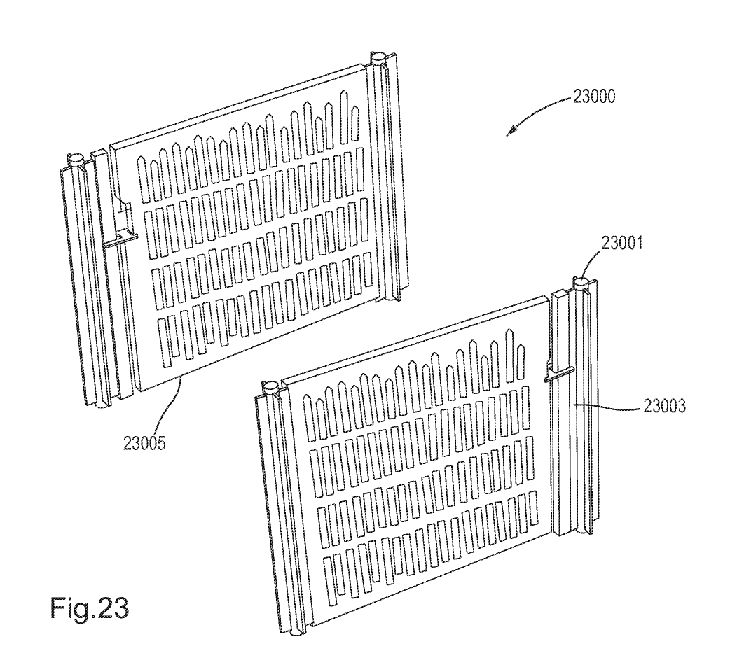

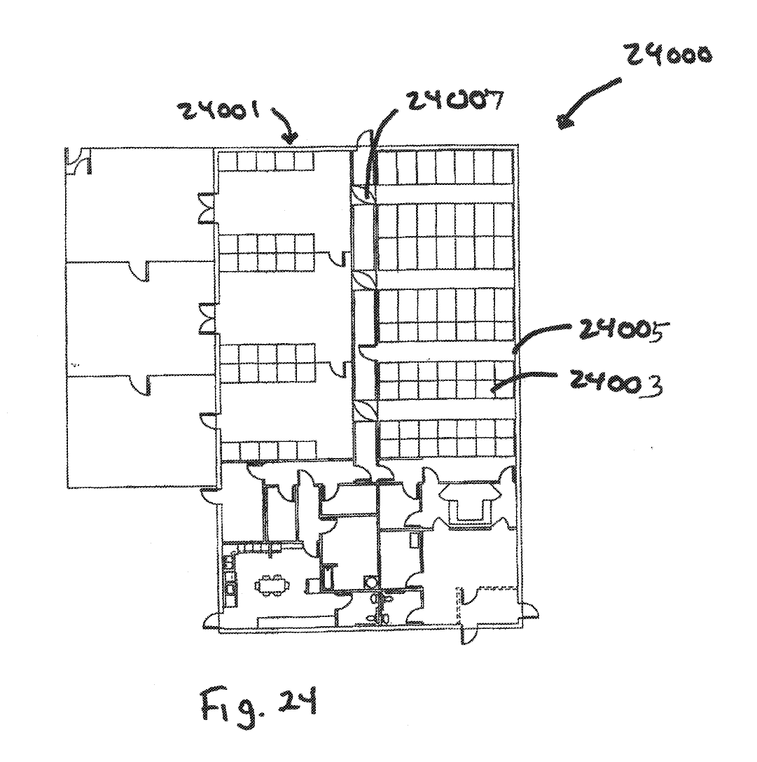

Referring to FIG. 23, two gates of the four-gate system are shown, 23000. As shown in FIG. 23, four posts are provided, 23001, wherein a gate panel is attached to two of the posts, 23003. A gate is then attached to each gate panel, 23005.

Referring to FIG. 24, an overall view of how one or more embodiments of the present inventions may be incorporated into a kennel facility is shown, 24000. As shown in FIG. 24, at 24001, a floor plan for an animal boarding facility is shown. The incorporation of the 4.0° deep×4.0° wide kennel enclosures of one or more inventions is shown with the kennel enclosures, 24003 and the walled enclosure, 24005 shown along with the incorporation of the four gate system is also shown, 24007.

At least one embodiment of one or more present inventions provide the ability to use an enclosed area for multiple purposes. Specifically, one or more present inventions provide the ability to use an enclosed area as an exercise area for an animal for a period of time during the day and then to quickly modify the area to install the kennel enclosures previously discussed to allow for animals to rest and sleep. One or more embodiments provide the ability to use an enclosed facility as a play area for 10 to 14 hours per day while also using the same enclosed area to hold kennel enclosures 12 to 16 hours per day. As shown in Table 1, an example of the time frames of how an enclosed facility may use one or more embodiments of the inventions disclosed may include beginning at 12:00 a.m. the enclosed facility is used to hold kennel enclosures, wherein the kennel enclosures have been erected into multiple rows to allow for animals to rest and sleep. After eight hours of rest, at 8:00 a.m., the kennel enclosures are disassembled and the enclosed facility is used as a recreation or exercise area. After four hours of recreation, at 12:00 p.m., the kennel enclosures are erected into multiple rows and the animals are allowed to rest and sleep. After two hours of rest, at 2:00 p.m., the kennel enclosures are disassembled and the enclosed area is used as a recreation area. After five hours of recreation, at 7:00 p.m., the kennel enclosures are reassembled into rows and the animals are allowed to rest and sleep.

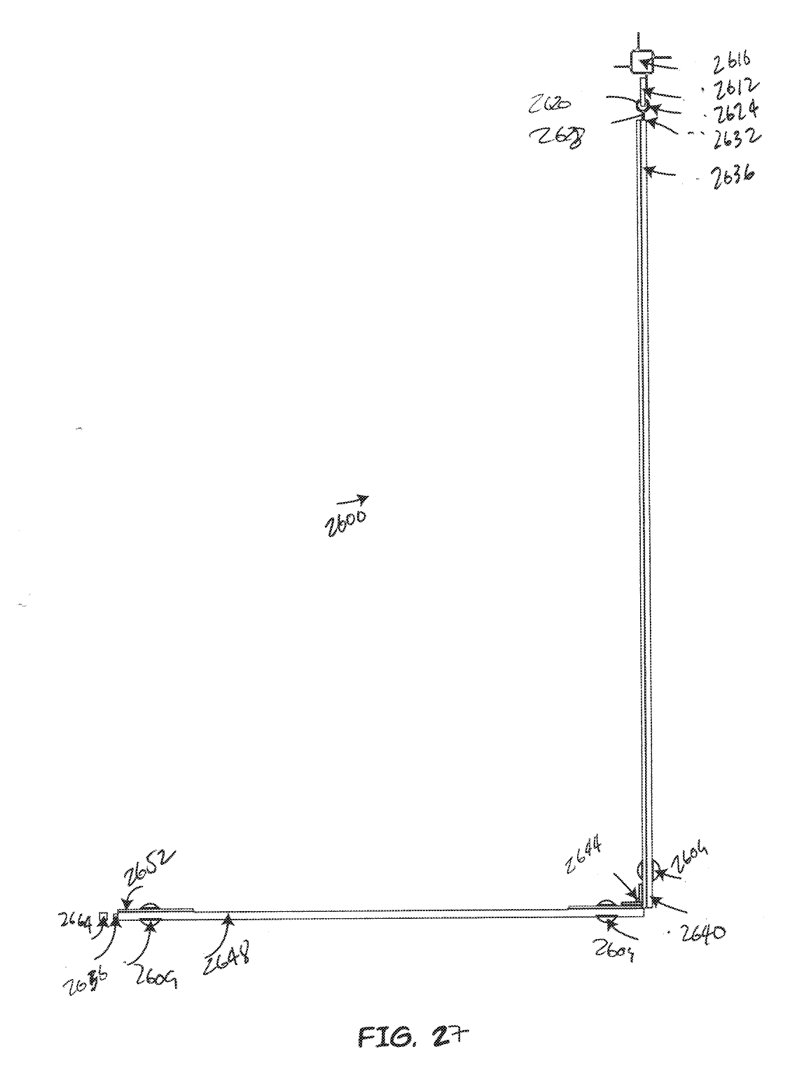

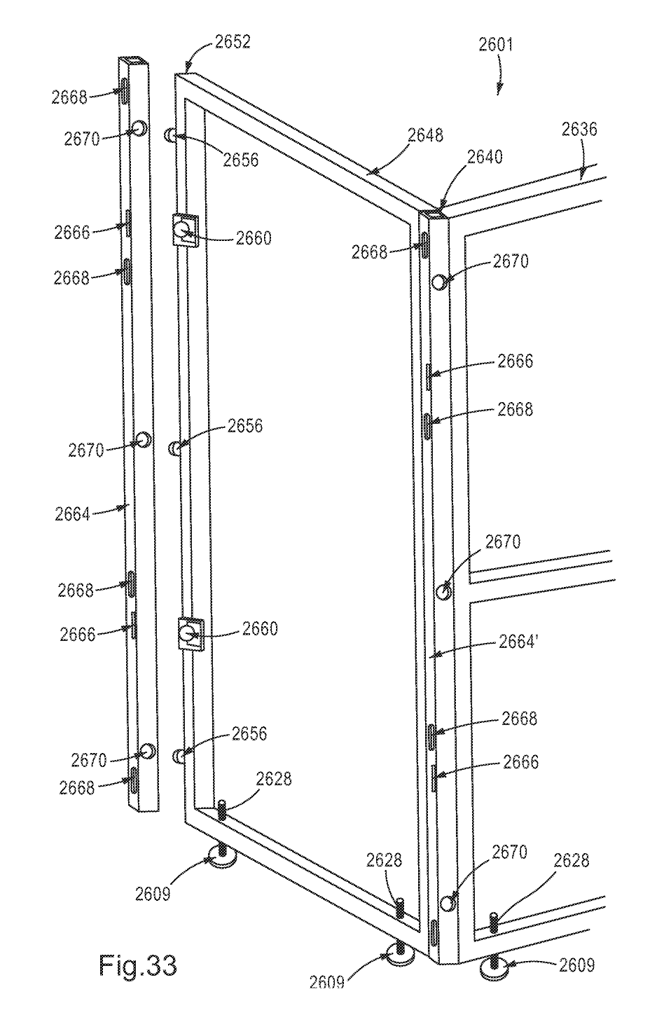

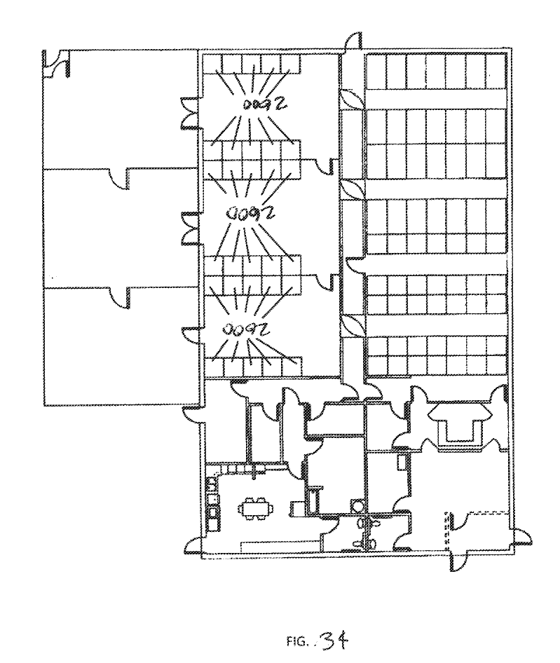

Referring now to FIG. 26, an embodiment of a multi-positionable or dynamic kennel system 2600 is shown in an expanded configuration. The embodiment shown in FIG. 26 utilizes two pre-existing barriers, including a first pre-existing barrier 2604 and a second pre-existing barrier 2608, wherein the first and second pre-existing barriers 2604 and 2608 may be transversely oriented. The pre-existing barriers 2604 and 2608 may include a variety of structures including an existing wall, an existing fence (e.g., a play-yard fence), an existing portion of a permanent kennel, or any barrier which is capable of providing adequate support and is of a sufficient length and height for serving as a side of a kennel. As shown in FIG. 26, at least one hinge plate 2612 may be coupled to one of the pre-existing barriers 2604, such as, but not limited to, through a kennel post 2616. An opposing side of each hinge plate 2612 may be coupled to a looped end 2620 of an eyebolt 2624. A threaded end 2628 of each eyebolt 2624 may be attached to a first lateral side 2632 of a side panel 2636. A second lateral side 2640 of the side panel 2636 may be attached to at least one butt hinge 2644, and another portion of the butt hinge 2644 may be attached to a front panel or gate 2648 of the kennel enclosure. A latchable end 2652 of the gate 2648 may contain protruding pins 2656 and rotary latches 2660 (as seen in FIG. 33), which are used to secure the opening end of the gate 2648 to an adjustment bar 2664. The adjustment bar 2664 may contain receptacles for the protruding pins 2656 and rotary latches 2660 of the gate 2648, and the adjustment bar 2664 attaches to the second existing barrier 2608, thereby completing the enclosure area.

FIG. 27 illustrates those elements that are needed to form a dynamic kennel enclosure in addition to the two pre-existing barriers 2604 and 2608 seen in FIG. 26. FIG. 27 further illustrates the additional elements needed to form a dynamic enclosure when the two pre-existing barriers 2604 and 2608 are transversely aligned to one another. FIG. 27 yet further illustrates the additional elements needed to form a dynamic enclosure when the two pre-existing barriers 2604 and 2608 are situated perpendicular to one another. All elements in FIGS. 27-34 use the element numbers provided within FIG. 26 for ease of reference.

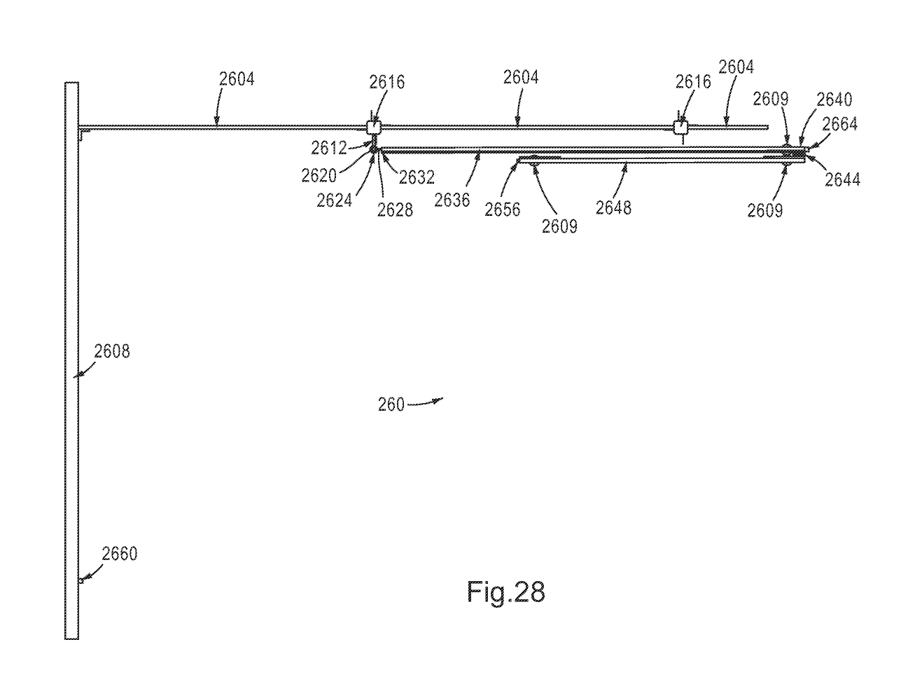

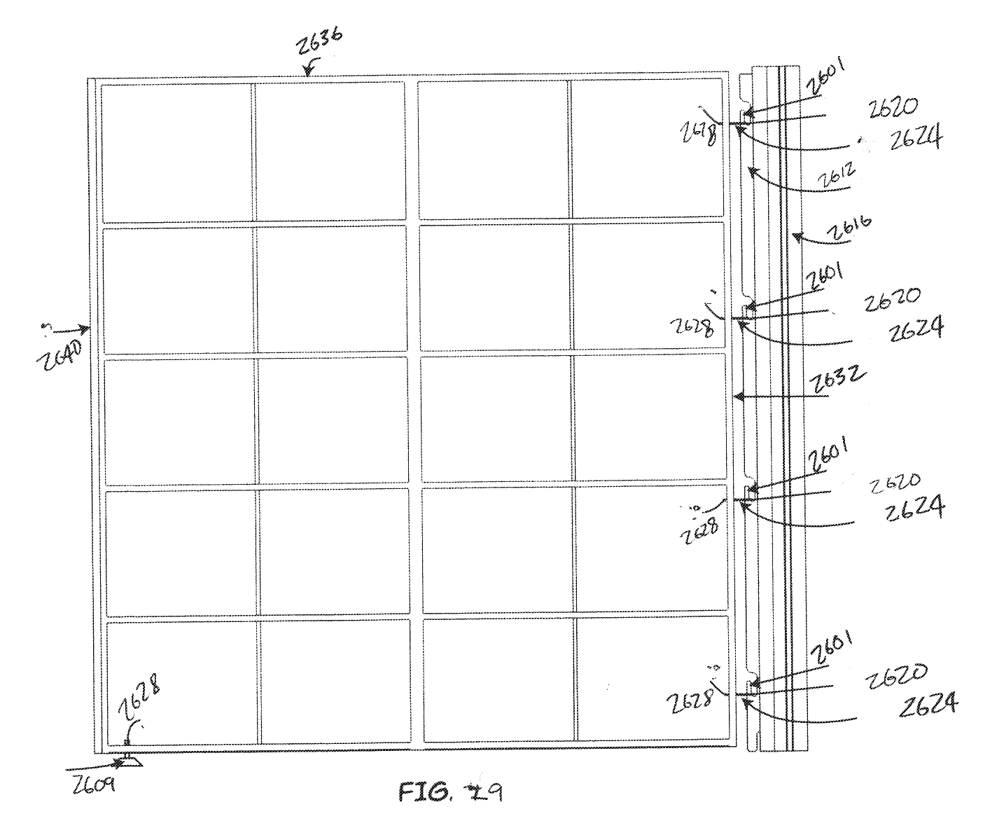

FIG. 28 is a top plan view of a dynamic kennel enclosure system 2600 that is in a collapsed configuration (i.e., when not in use or housing an animal). In one such embodiment, the hinge plate 2612 may be used to pivot the side panel 2636 approximately 90° so that the side panel is substantially parallel to a pre-existing barrier 2604. In addition, the gate 2648 may also pivot along with the side panel 2636. The gate may rotate about 90°, on one or more butt hinges 2644, relative to the side panel 2636 so that the gate 2648 may be substantially parallel to the side panel 2636 and the pre-existing barrier 2604. The one or more butt hinges 2644 which join the gate 2648 and side panel 2636 allows for an unencumbered pivoting of the gate 2648, and for the gate 2648 to parallely line up with the side panel 2636.

Referring now to FIG. 29, detail of an embodiment of a side panel 2636 is shown. In at least one embodiment, multiple eyebolts 2624 may be threadably coupled to the side panel 2636. A looped end 2620 of each eyebolt 2624 may be operatively associated with a corresponding receiving element 2601 situated on the outer side of the hinge plate 2612. One embodiment illustrates four eyebolts 2624 used for this purpose. Other embodiments may utilize less or more eyebolts, as necessary, to provide sufficient support for the side panel 2636, while providing a secure attachment of the side panel 2636 to the hinge plate 2612. Accordingly, a first side of the hinge pate 2612 may be attached vertically to the kennel post 2616, and the exposed opposite side of the hinge plate 2612 may receive the looped ends 2620 of eyebolts 2624, which may be attached to a first end 2632 of the side panel 2636.

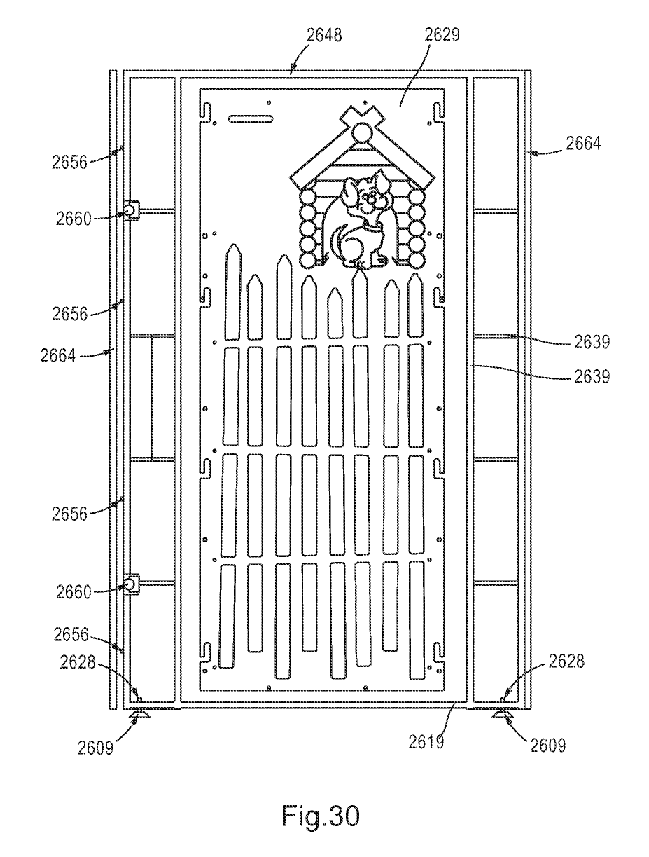

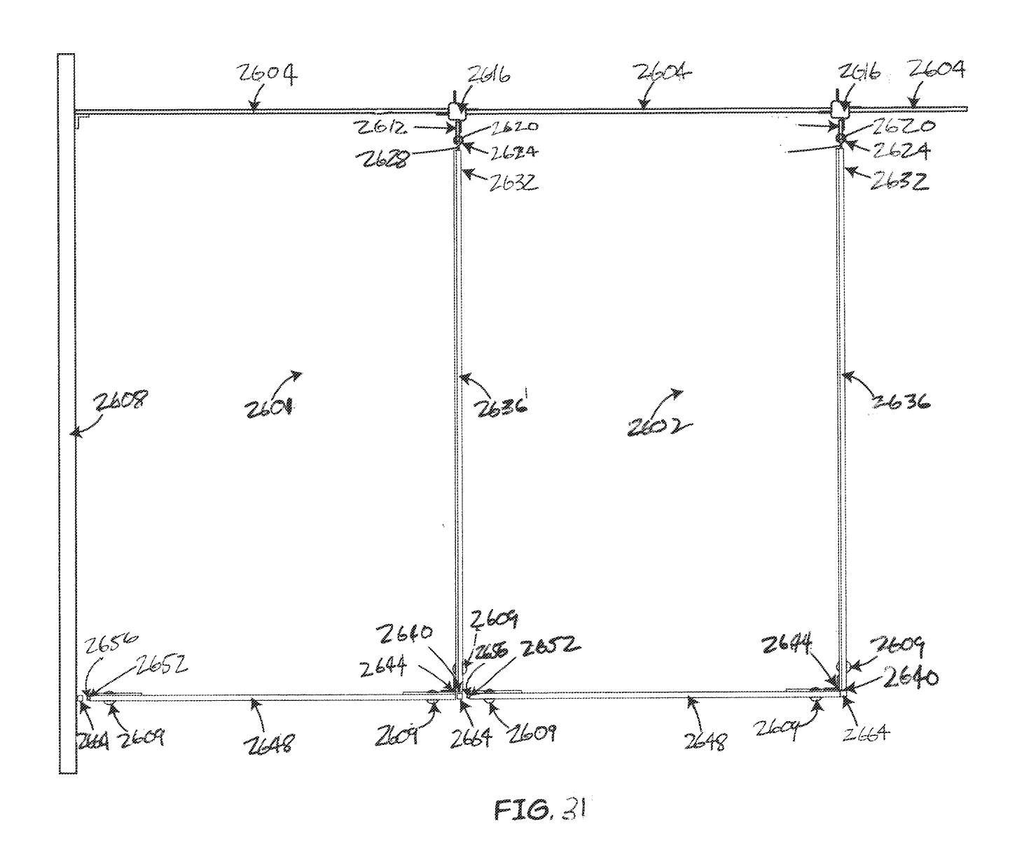

Referring now to FIG. 30, a front elevation view of a gate 2648 is shown. The gate 2648 may comprise a variety of configurations; however, one gate 2648 may be selectively secured to an adjustment arm 2660 at one side of the gate 2648 comprising an opening side. In addition, the gate 2648 may be able to be moved to a position such as, but not limited to, a store position. In one store position, the gate 2648 may be substantially parallel to at least one of the side panel 2636 and a pre-existing barrier 2604 and 2608, as seen in FIG. 26. The gate 2648 may include a sheet member operatively associated with a frame to aid in holding and supporting the sheet member.

Referring to FIGS. 26-30, in one embodiment a glider 2609 may be provided on a bottom of a side panel 2636, such as at a corner opposing the hinge plate 2612. The glider 2609 may be used to provide easier opening of the system 2600 (i.e., moving the side panel 2636 from the closed configuration seen in FIG. 28 to the expanded configuration seen in FIG. 26) and closing the side panel 2636 (i.e., placing the side panel 2636 from the open configuration seen in FIG. 26 to the stored or collapsed configuration seen in FIG. 28) by creating a surface with less friction between the collapsible kennel members and the floor. This allows the panel 2636 and system 2600 to more easily slide across the floor and into the desired configuration. The glider 2609 also helps support the weight of the side panel 2636, thereby reducing stress on the eyebolts 2624 and hinge plate 2612. The glider 2609 may be made of any material that reduces friction when slid across a flooring surface, including a support with a plastic base or a lockable caster wheel. Other materials and devices known in the art are contemplated. Gliders 2609 may be adjustably and detachably attached to the bottom of the gates 2648 and side panels 2636. As seen in FIG. 30, the gliders 2609 may also be attached to a gate frame 2619 to allow for vertical movement of the glider in the frame 2619, thereby adjusting for bumps and other vertical differences in a flooring surface and to allow for vertical adjustment of the glider 2609 across the floor. One embodiment of a glider 2609 may be coupled to the frame 2619 through a threaded bolt/nut configuration.

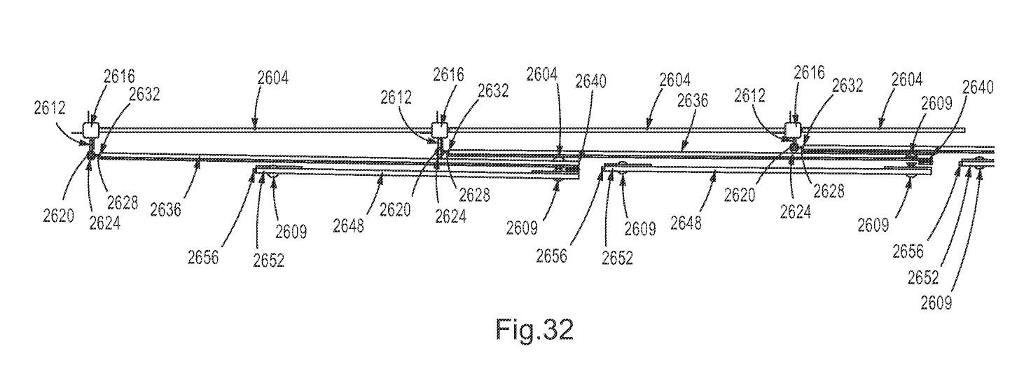

Referring now to FIGS. 31 and 32, and in accordance with at least one embodiment, a dynamic kennel system with multiple collapsible kennels is shown, wherein the kennels are situated next to each other. FIG. 31 illustrates a plurality of kennels, wherein a second kennel 2602 with three moveable sides is situated next to a first kennel 2601 with two moveable sides. The common side panel 2636′ between the two kennel units may serve to hold an adjustment bar 2664 for the second kennel 2602. As seen in FIG. 33, a second adjustment bar 2664′ may be attached to the first kennel 2601, so an adjacent kennel enclosure 2602 may be engaged and attached to the second adjustment bar 2664′ by use of pins 2656 and rotary latches 2660. As further shown in FIG. 33, the gate 2648 may comprise pins 2656 which outwardly extend from the gate 2648 and which may be received in complementary receiving holes 2670 in the adjustment bar 2664. The pins 2656 may act as guides for lining up the front panel gate 2648 to the adjustment bar 2664 and are able to absorb most of the force an enclosed dog may impart on the kennel 2600. Once the pins 2656 are in place, rotary latches 2660 on the front panel gate 2648 may be engaged with latch keepers 2666 located on the adjustment bar 2664 to lock the front panel gate 2648 into place while the kennel 2600 is in use by an animal. It is contemplated that the term front panel gate 2648 may also be referred to herein as a front panel 2648 or a gate 2648. In one embodiment, the adjustment bar 2664 may also include slotted holes 2668 that may allow for adjustment while the bar 2664 is being attached to a pre-existing barrier 2604 and 2608. FIG. 33 shows that the placement of the gliders 2609 on the bottom side of the front panel 2648 and may be located on opposing ends from each other.

FIG. 31 shows multiple collapsible kennels 2600 situated next to each other and illustrates how once a temporary kennel 2600 is engaged, it may serve as one of the pre-existing barriers 2604 and 2608 for an adjacent temporary kennel enclosure 2600. A second adjustment bar 2664, as shown in FIG. 33, may be attached to the engaged temporary kennel 2600, so an adjacent kennel enclosure 2600 may be engaged and attached to the second adjustment bar 2664 by use of pins 2656 and rotary latches 2660.

At least one embodiment of the one or more present inventions provides a second adjustment bar 2664. The second adjustment bar 2664 may be attached to the side of the front panel 2648 and transverse to the placement of the butt hinge 2644, so that the second adjustment bar 2664 does not impede the movement of the butt hinge 2644. The second adjustment bar 2664 may be attached in a secure manner. In one embodiment, the second adjustment bar 2664 may be coupled to the front panel 2648 through a bolt/nut coupling mechanism. Other mechanisms known in the art are contemplated.

At least one embodiment of the one or more present inventions provides at least one butt hinge 2644. The butt hinge 2644 may be made of material which provides sufficient strength to attach the side panel 2636 and gate 2648, and to support the gate 2648. A first side of the butt hinge 2644 may be attached vertically to an inner side of the side panel 2636 near the edge which opposes the side attached to the hinge panel 2640. A second side of the butt hinge 2644 may be attached vertically to the inner side of a gate 2648 near the edge which opposes the protruding pins 2656. In one embodiment the butt hinge 2644 may comprise one hinge or multiple hinges. One embodiment comprises three butt hinges 2644 of approximately 8 inches each.

FIG. 32 comprises is a top plan view of multiple kennel enclosures 2600 that are collapsed when not in use and which shows how the collapsed panels of one enclosure 2601 aligns with the collapsed panels of the enclosure 2602 that is situated next to it.

FIG. 34 is a top plan view providing an example of a dog kennel facility with the collapsible kennels 2600 engaged and in use. This figure illustrates how the areas may be divided to accommodate additional animals with separate kenneling areas.

In at least one embodiment, the side panels 2636 and gate 2648 may comprise a sheet member 2629 held within a frame 2619. The sheet member 2629 may comprise metal, plastic, wood or other materials and combinations thereof. One such embodiment comprises a sheet member 2629 of high density polyethylene (HDPE). For embodiments described herein, sheet members 2629, frames 2619, as well as the kennel posts 2616, adjustment bars 2664, and any other portion of the system 2600 may be made of a material providing suitable strength and other characteristics for their intend application. By way of example and not limitation, these elements may be made of wood, plastic, metal, metal alloys, carbon fiber, fiberglass, or combinations thereof. In at least one embodiment, the frame 2619 may comprise a structure around at least a portion of a perimeter of the sheet member 2629. Accordingly, in at least one embodiment, the frame 2619 may comprise an outer structure, and may not include one or more vertical, horizontal and/or diagonally oriented supports within an interior portion of the side panel adjacent the sheet member. Alternatively, the frame 2619 may include one or more vertical, horizontal and/or diagonally oriented supports (such as seen in FIG. 30, where an interior portion of the frame 2619 for the gate 2648 comprises various additional horizontal and vertical supports 2639. Such various additional horizontal and vertical supports 2639, as well as the sheet member 2629 may be included in the side panel 2636, as seen in FIG. 33.

The present invention may be embodied in other specific forms without departing from its spirit or essential characteristics. The one or more present inventions, in various embodiments, include components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes (e.g., for improving performance, achieving ease and/or reducing cost of implementation).

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own.

Moreover, though the description of the invention has included description of one or more embodiments and certain variations and modifications, other variations and modifications are within the scope of the invention (e.g., as may be within the skill and knowledge of those in the art, after understanding the present disclosure). It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

TABLE 1
Enclosed facility usage over a 24 hour period

| Time | Facility usage |
|---|---|
| 12:00 a.m. | Kennel enclosures used for animal rest |
| 1:00 a.m. | Kennel enclosures used for animal rest |
| 2:00 a.m. | Kennel enclosures used for animal rest |
| 3:00 a.m. | Kennel enclosures used for animal rest |
| 4:00 a.m. | Kennel enclosures used for animal rest |
| 5:00 a.m. | Kennel enclosures used for animal rest |
| 6:00 a.m. | Kennel enclosures used for animal rest |
| 7:00 a.m. | Kennel enclosures used for animal rest |
| 8:00 a.m. | Kennel enclosures dismantled and facility |
| | used for animal recreation |
| 9:00 a.m. | Facility used for animal recreation |
| 10:00 a.m. | Facility used for animal recreation |
| 11:00 a.m. | Facility used for animal recreation |
| 12:00 p.m. | Kennel enclosures erected for animal rest |
| 1:00 p.m. | Kennel enclosures used for animal rest |
| 2:00 p.m. | Kennel enclosures dismantled and facility |
| | used for animal recreation |
| 3:00 p.m. | Facility used for animal recreation |
| 4:00 p.m. | Facility used for animal recreation |
| 5:00 p.m. | Facility used for animal recreation |
| 6:00 p.m. | Facility used for animal recreation |
| 7:00 p.m. | Kennel enclosures erected for animal rest |
| 8:00 p.m. | Kennel enclosures used for animal rest |
| 9:00 p.m. | Kennel enclosures used for animal rest |
| 10:00 p.m. | Kennel enclosures used for animal rest |
| 11:00 p.m. | Kennel enclosures used for animal rest |
| 12:00 a.m. | Kennel enclosures used for animal rest |

What is claimed is:

1. A kennel enclosure system for attachment to a floor, comprising:
a plurality of anchors placed into the floor;
a plurality of panels;
a plurality of posts;
a gate panel;
a gate; and
two stabilization bars, wherein,
at least some of the plurality of posts are attached to one or more anchors of the plurality of anchors placed in the floor,
the plurality of panels are attached to the plurality of posts to create a walled enclosure,
a first panel of the plurality of panels is attached to a post in the walled enclosure,
the first panel is attached to a first front post,
a second panel is attached to a second post in the walled enclosure,
the second panel is attached to a second front post,
the gate panel is attached to the first front post,
the gate is attached to the gate panel thereby creating a first kennel enclosure, and
the two stabilization bars are attached to the front posts.

2. The kennel enclosure system of claim 1, wherein the plurality of posts are a metal, hollow tube with appendages on each face of the tube.

3. The kennel enclosure system of claim 2, wherein the plurality of panels are plastic and have a rubber seal at a base of the panel.

4. The kennel enclosure system of claim 1, wherein the floor with the walled enclosure is used as a recreation area for 10 to 14 hours per day; and the kennel enclosure is erected on the floor and used as a kennel 12 to 16 hours each day.

5. A method of configuring a kennel comprising:
providing a first kennel enclosure comprising:
attaching a first panel to a first post and attaching the first panel to a second post,
attaching a second panel to a third post and attaching the second panel to a fourth post,
attaching a third panel to the second post and attaching the third panel to the third post thereby creating a first kennel enclosure,
attaching a first gate panel to the first post at the front of the enclosure,
attaching a first gate to the first gate panel,
attaching two stabilization bars, wherein a first stabilization bar is attached to an appendage on the first front post and is attached to an appendage on the third front post above the gate and a second stabilization bar is attached to an appendage on the first front post and is attached to an appendage on the third front post below the gate; and
providing a second kennel enclosure attached to the first kennel enclosure comprising:
attaching a fourth panel to a fifth post and attaching the fourth panel to a sixth post,
attaching a fifth panel to the second post of the first kennel enclosure and attaching the fifth panel to the sixth post thereby creating a second kennel enclosure attached to the first kennel enclosure,
attaching a second gate panel to the fifth post,
attaching a second gate to the second gate panel, and
attaching two stabilization bars, wherein a third stabilization bar is attached to an appendage on the first front post and is attached to an appendage on the third front post above the gate and a fourth stabilization bar is attached to an appendage on the first front post and is attached to an appendage on the third front post below the gate.

6. The method of configuring a kennel of claim 5 further comprising a plurality of metal posts, the plurality of metal posts comprising,
a plurality of walled enclosure posts; and
a plurality of kennel posts, wherein,
the plurality of panels comprises,
a plurality of walled enclosure panels, and
a plurality of kennel panels,
the plurality kennel posts and plurality of kennel panels are coupled together to create at least one of the first and the second kennel enclosure, and
the walled enclosure posts and the walled enclosure panels are coupled together to create a walled enclosure around at least one of the first and the second kennel enclosures.

7. The method of configuring a kennel of claim 6 further comprising:
erecting at least one of the first kennel enclosure and the second kennel enclosure on a recreation floor area;
using at least one of the first kennel enclosure and the second kennel enclosure as an animal kennel recreation area for at least 10 to 16 hours per day.

8. A method of configuring a dynamic kennel comprising:
providing a first kennel enclosure comprising:
attaching a first panel to a first post and attaching the first panel to a second post,
attaching a second panel to a third post and attaching the second panel to a fourth post,
attaching a third panel to the second post and attaching the third panel to the third post thereby creating a first kennel enclosure,
attaching a first gate panel to the first post at the front of the kennel enclosure,
attaching a first gate to the first gate panel,
attaching two stabilization bars, wherein,
a first stabilization bar of the two stabilization bars is attached to,
a first appendage on a first metal post, and
a second appendage on a third metal post above the gate,
a second stabilization bar of the two stabilization bars is attached to,
another appendage on a first metal post, and
another appendage on a third metal post below the gate; and
providing a second kennel enclosure attached to the first kennel enclosure comprising:
attaching a fourth panel to the second post of the first kennel enclosure,
attaching the fourth panel to a fifth post,
attaching a fifth panel to the fourth post of the first kennel enclosure,
attaching the fifth panel to a sixth post thereby creating a second kennel enclosure,
attaching a second gate panel to the fifth post,
attaching a second gate to the second gate panel, and
attaching two second kennel stabilization bars, wherein,
a first second kennel stabilization bar is attached to an appendage on the first metal post and is attached to an appendage on the third metal post above the gate;
a second second kennel stabilization bar is attached to an appendage on the first metal post and is attached to an appendage on the third metal post below the gate.

9. The method of configuring a dynamic kennel of claim 8 further comprising:
using a floor is used as a recreation area for 10 to 14 hours per day; and
erecting the first kennel enclosure and the second kennel enclosure on the floor;
using the first kennel enclosure and the second kennel enclosure as animal kennels 12 to 16 hours per day.

10. A dynamic kennel system for use in combination with a pre-existing barrier, the dynamic kennel system, comprising:
at least one side panel rotatably interconnected to the pre-existing barrier; and
a gate rotatably interconnected to the at least one side panel, wherein,
the at least one side panel and the gate are positionable in a first collapsed configuration such that the at least one side panel and the gate are situated substantially parallel with each other, and wherein the at least one side panel and the gate are positionable in a second expanded configuration such that the at least one side panel and the gate are situated transverse with each other.

11. The dynamic kennel system of claim 10, wherein in the second expanded configuration the at least one side panel and the gate are situated substantially perpendicular with each other.

12. The dynamic kennel system of claim 10, further comprising at least one post situated between the at least one side panel and the pre-existing barrier.

13. The dynamic kennel system of claim 10, wherein an opening side of the gate includes one or more protruding pins that selectively secure the gate to an adjustment bar aligned with the opening side of the gate when the gate is in a closed position.

14. The dynamic kennel system of claim 13, wherein the adjustment bar contains receiving holes for the protruding pins when the gate is in a closed position.

15. The dynamic kennel system of claim 10, wherein an opening side of the gate includes one or more rotary latches that selectively secure the gate to an adjustment bar aligned with the opening side of the gate when the gate is in a closed position.

16. The dynamic kennel system of claim 15, wherein the adjustment bar contains receiving holes for the rotary latches when the gate is in a closed position.

17. The dynamic kennel system of claim 10, wherein the adjustment bar is attached to a pre-existing barrier.

18. A dynamic kennel system within an animal boarding facility, comprising:
a first pre-existing barrier transversely connected to a second pre-existing barrier within the animal boarding facility;
a side panel engaging the first pre-existing barrier using means for rotatably interconnecting the side panel to the first pre-existing barrier; and
a gate hingedly attached to the side panel, wherein,
the first pre-existing barrier, the second pre-existing barrier, the side panel and the gate are adapted to form a temporary enclosure,
the side panel and the gate are positionable in a first collapsed configuration such that the side panel and the gate are situated substantially parallel with each other, and wherein the side panel and the gate are positionable in a second expanded configuration such that the side panel and the gate are situated transverse with each other to form the temporary enclosure.

19. The dynamic kennel system of claim 18, wherein the means for rotatably interconnecting the side panel to the first pre-existing barrier includes a post, a hinge plate, and a plurality of eyebolts.

20. The dynamic kennel system of claim 18, wherein in the second expanded configuration the side panel and the gate are situated substantially perpendicular with each other.

21. The dynamic kennel system of claim 18, wherein an opening lateral end of the gate includes one or more protruding pins that selectively secure the gate to an adjustment bar aligned with the opening lateral end of the gate when the gate is in a closed position.

22. The dynamic kennel system of claim 21, wherein the adjustment bar contains receiving holes for the protruding pins when the gate is in a closed position.

23. The dynamic kennel system of claim 18, wherein an opening lateral end of the gate includes one or more rotary latches that selectively secure the gate to an adjustment bar aligned with the opening lateral end of the gate when the gate is in a closed position.

24. The dynamic kennel system of claim 23, wherein the adjustment bar contains receiving holes for the rotary latches when the gate is in a closed position.

25. The dynamic kennel system of claim 23, wherein the adjustment bar is attached to the second pre-existing barrier.

26. A dynamic kennel system for use in combination with one or more pre-existing barriers, the dynamic kennel system, comprising:
at least one side panel rotatably interconnected to a first pre-existing barrier of the one or more pre-existing barriers; and
a gate rotatably interconnected to the at least one side panel, wherein,
the at least one side panel and the gate are positionable in a first collapsed configuration such that the at least one side panel and the gate are situated substantially parallel with each other, and
the at least one side panel and the gate are positionable in a second expanded configuration such that the at least one side panel and the gate are situated transverse with each other.

27. The dynamic kennel system of claim 26, wherein in the second expanded configuration the at least one side panel and the gate are situated substantially perpendicular with each other.

28. The dynamic kennel system of claim 26, further comprising at least one post situated between the at least one side panel and the first pre-existing barrier of the one or more pre-existing barriers.

29. The dynamic kennel system of claim 26, wherein an opening side of the gate includes one or more protruding pins that selectively secure the gate to an adjustment bar aligned with the opening side of the gate when the gate is in a closed position.

30. The dynamic kennel system of claim 29, wherein the adjustment bar contains receiving holes for the protruding pins when the gate is in a closed position.

31. The dynamic kennel system of claim 26, wherein an opening side of the gate includes one or more rotary latches that selectively secure the gate to an adjustment bar aligned with the opening side of the gate when the gate is in a closed position.

32. The dynamic kennel system of claim 31, wherein the adjustment bar contains receiving holes for the rotary latches when the gate is in a closed position.

33. The dynamic kennel system of claim 26, wherein the adjustment bar is attached to a second pre-existing barrier of the one or more pre-existing barriers.

34. A method of forming a dynamic kennel system for use in combination with one or more pre-existing barriers, the method comprising:
rotatably interconnecting at least one side panel to a first pre-existing barrier of the one or more pre-existing barriers; and
rotatably interconnecting a gate to the at least one side panel, wherein,
the at least one side panel and the gate are positionable in a first collapsed configuration such that the at least one side panel and the gate are situated substantially parallel with each other, and
the at least one side panel and the gate are positionable in a second expanded configuration such that the at least one side panel and the gate are situated transverse with each other.

35. A method of using a dynamic kennel system that resides adjacent one or more pre-existing barriers, the method comprising:
placing members of an enclosure in an expanded configuration by:
positioning a first member, the first member comprising a side panel, transverse to a first pre-existing barrier of the one or more pre-existing barriers, wherein the first member is rotatably interconnected to the first pre-existing barrier, and
positioning a second member, the second member comprising a gate, transverse to the first member, wherein the second member is rotatably interconnected to the side panel; and
placing members of the enclosure in a collapsed configuration by:
moving the first member toward the first pre-existing barrier such that the first member is substantially parallel with the first pre-existing barrier, and
moving the second member toward the first pre-existing barrier and the first member such that the second member is substantially parallel with both the first pre-existing member and the first member.

36. A method of using a dynamic kennel system that resides adjacent one or more pre-existing barriers, the method comprising:
forming an enclosure into a temporary kennel configuration by:
positioning a side panel transverse to a first pre-existing barrier of the one or more pre-existing barriers, wherein the side panel is rotatably interconnected to the first pre-existing barrier, and
positioning a gate transverse to the side panel, wherein the gate is rotatably interconnected to one of the side panel or a second pre-existing barrier of the one or more pre-existing barriers; and
storing the enclosure in a collapsed configuration by:
moving the side panel toward the first pre-existing barrier such that the side panel is substantially parallel with the first pre-existing barrier, and
moving the gate toward at least one of the second pre-existing barrier or the side panel such that the gate is substantially parallel to at least one of the first pre-existing barrier, the second pre-existing barrier, or the side panel.
